(19) United States
(12) Patent Application Publication
(10) Pub. No.: US 2002/0065890 A1
(43) Pub. Date: May 30, 2002

(54) Internet based automated outbound message delivery method and system

(76) Inventor: Ira Barron, Boulder, CO (US)

Correspondence Address: SHERIDAN ROSS PC, 1560 BROADWAY, SUITE 1200, DENVER, CO, 80202

(21) Appl. No.: 09/725,544

(22) Filed: Nov. 29, 2000

Related U.S. Application Data
(60) Provisional application No. 60/168,704, filed on Dec. 3, 1999.

(51) Int. Cl. G06F 15/16

(52) U.S. Cl. 709/206

(57) ABSTRACT

An Internet based, accessed, manipulated and administered automated outbound message delivery method and system. The present method and system allows the user to transmit a message to a database comprised of phone numbers, pager numbers, fax numbers, e-mail addresses and mailing addresses. A call initiator sets the message delivery parameters and the message is then transmitted to the database through a plurality of outgoing phone lines.

### RELATED APPLICATION

This application claims priority from U.S. Provisional Patent Application No. 60/168,704 filed on Dec. 3, 1999. The entire disclosure of the provisional application is considered to be part of the disclosure of the accompanying application and is hereby incorporated by reference.

### FIELD OF THE INVENTION

The present invention relates to a telecommunication system and method, and in particular, to an internet based, accessed, manipulated and administered automated outbound message delivery method and system which will initiate a phone call and transmit messages over outgoing phone lines to a database.

### BACKGROUND OF THE INVENTION

Today, a person who wants to deliver a time-sensitive message to a large group of people has limited alternatives. He or she may utilize a traditional automated outbound messaging system, which involves the purchase of expensive hardware and/or software or he/she can use a voice messaging method. There are shortcomings with both of these approaches. The cost of the hardware and software and line rentals needed to effectuate an automated outbound calling system may be prohibitive for many individuals or small organizations. These people are excluded from participating in automated outbound messaging through this route. Another approach is to use a phone messaging service such as CoachCall™ or Mr. Notify or e-mail messaging service such as Evite. These messaging methods are limited in their user interface, in the ways to input messages and input to and manage the database of parties to be notified, the ways to deliver messages, and the ways the provider gets remunerated for delivering messages. For example, some methods, e.g. Mr. Notify, require that the called party be forced to listen to an unsolicited advertisement before they can hear the message. This approach deters customers who do not want to subject the called party to such an annoyance while it limits the length of the informational part of the message. An advertiser-supported method also imposes a significant constraint on how many messages can be delivered within a given period of time since it requires time for the advertisement and this consumes resources in the telecommunications system.

Present methods are limited in their utility, in that they severely restrict the number of called parties that can be placed within a database and they also restrict the number of databases that a user can create. No method presently exists that allows a user to create a database of phone numbers, pager numbers, fax numbers, e-mail addresses, and mailing addresses by a multitude of methods such as by entering information directly into fields provided on a web page, downloading information in a standard file format, cutting and pasting information from another application, or cutting and pasting information from a previously created database. Additionally, no method presently exists that can support the construction of a voice message by a multitude of methods including: downloading a digital file, recording a digital file on-line or typing in a text message that will be converted to speech, and recording a voice message on a non-Internet platform. Moreover, no present method or system provides the requisite support for text-to-speech message transmission in a plurality of languages.

Some of the parties that a user needs to reach may be contacted more effectively by e-mail or pager than a phone, therefore, there are many times when a user may need to transmit a combined broadcast e-mail, pager, fax and voice message. They may also have a need to solicit and capture responses from the called parties, whether they are touch-tone or voice responses. The user may also need to retrieve the captured responses to a message by utilizing e-mail, voice mail or facsimile. There does not exist, however, any present method or system that can provide all of these features.

Further, no present method or system offers a monetary incentive for distributing information to its members and other interested parties through an Internet based automated outbound messaging service. By utilizing an Internet based outbound messaging method which offers a reward program, organizations could re-direct their limited manpower and monetary resources to other important areas.

In addition, no present method or system efficiently integrates an outbound calling system with a call distribution network to minimize peak load demands on the switch and network transmission facilities. No method offers an option to buffer or delay the transmission of messages to coincide with non-peak periods of activity for the call distribution network providing the message delivery function. Also, no present method or system extends to the user a price discount or rebate for exercising this buffering option.

Nor do present methods or systems include any marketing structures or business methods that offer companies and organizations the ability to co-brand with an Internet based automated outbound messaging system in order to present the service as theirs or to deliver targeted customer specific banner advertising.

### SUMMARY OF THE INVENTION

In view of the foregoing, one object of the present invention is to provide a method and system involving an internet-based automated outbound messaging system in order to overcome the deficiencies identified above. An easily accessible automated outbound messaging method may thus be provided to any user via the Internet without the necessity of that user purchasing any expensive hardware or software and with little or no requirement for specialized equipment to be in their possession.

A related object is to provide an internet based automated outbound messaging method and system that utilizes a graphical user interface (GUI) through which a user may access, create, and edit data, set parameters to manage the message transmission, and pay for the service, or effectively access, accomplish, manipulate and administer all of the aspects of said method and/or system.

Another object of the present invention is to provide a method and system that allows a user to send messages to a fundamentally unlimited number of databases comprised of an unlimited number persons and the numbers at which they can be contacted.

Yet another object is to provide a method and system by which an outbound voice or e-mail message can be broadcast to a database of phone numbers, pager numbers and e-mail addresses.

A further object is to provide a method and system by which a user may construct a database of phone numbers by downloading information in a standard file format, entering information into fields provided on a web page or may do so by cutting and pasting information directly from other standard file formats.

Yet a further object is to provide a method and system which will allow a choice of a plurality of languages in which a text-to-speech message can be transmitted.

An additional object is to provide a method by which a user may conveniently create a digital audio file on-line, or download a digital audio file that will constitute the message that is transmitted to a database.

The present method and system will also allow the user to solicit and capture touch-tone (digital) or voice responses and to retrieve said responses by either voice mail, e-mail or facsimile.

In keeping with the foregoing, yet a further object is to provide an automated outbound messaging method and system where the cost for sending a message is calculated on a charge-per-message basis or a charge per minute basis and that charge can be billed to a credit card using an e-commerce interface.

An added object is to provide an ability to delay or of buffer the transmission of messages to coincide with non-peak periods of activity for the call distribution network providing the message delivery function. A relational object would be to allow users of the present invention to receive a price discount or rebate for exercising this buffering option.

Yet a further related object is to provide a monetary reward method and system to organizations and their affiliates who utilize the present invention.

The present invention provides a new and unique marketing structure and business method to advertisers that heretofore has not existed in an Internet based automated outbound messaging system. That structure offers companies and organizations the opportunity to co-brand with CallMachine.com so that the web page that a user interacts with appears to be presented by them.

Another unique object is to provide companies and organizations with an opportunity to purchase customer specific banner advertising that will appear on the web page of the present invention.

The automated outbound messaging system and method of the present invention finds application in a wide range of socially, commercially and politically essential activities. Examples include: Sports teams to inform members of a game or practice or to alert them of a cancellation; corporations to distribute company-wide messages or to deliver information about a special sale to a list of VIP customers; a company such as a ski shop to notify key customers of conditions at select ski resorts; children's organizations to inform members of changes in their meeting plans; daycare centers and schools which notify parents of changes in operating hours during severe weather; groups of friends send messages to each other to organize outings such as hikes, trips to the lake, or dinner at a restaurant; members of families send messages to each other to arrange for reunions or to relate important events in their lives e.g., births, newjobs, awards that children and grandchildren have won; fan clubs sending messages to their members alerting them of an upcoming appearance by their favorite performer; professional organizations informing their members of a conference or tradeshow; public Affairs groups organizing rallies and protests by sending messages about where and when to meet; political, religious, and public affairs organizations sending messages to their members notifying them of an issue of concern and informing them if they need help in a letter writing campaign; human Rights organizations contacting members and organizing protests concerning an important issue; political organizations sending messages to constituents letting them know that there is a write-in candidate in an election; veterans groups taking part in an event such as a parade send reminder messages with meeting times and locations for the event; performing Arts organizations sending messages about concerts, film festivals, plays, etc. to interested members; churches sending messages to their members to solicit assistance for a person with a special need, for a community project, or to inform them about changes in meeting times for special events; relief organizations sending messages in order to fill the need for food, clothing, shelter or medical assistance in disaster struck communities; and cities or counties sending messages to its citizens about a water use restriction, high fire danger, or travel limitation request due to pollution levels.

### BRIEF DESCRIPTION OF THE DRAWINGS

FIG. 1 shows a flow chart of the Main Routine, of the present invention, that a user would follow.

FIG. 2 shows a flow chart of the Contractual Subroutine, prompting the user to accept the contractual terms of the present invention.

FIG. 3 shows a flow chart of Account Information Subroutine through which the user advances to one of several related subroutines in order to enter information for billing and correspondence purposes.

FIG. 4 shows a flow chart of the New Message Initiator Account Information Subroutine in which a new user is prompted for entry of personal information: name, password, mailing address, phone number, e-mail address, billing (credit card) information or Purchase Order number.

FIG. 5 shows a flow chart the Existing Message Initiator Account Information Subroutine through which a user may display and edit previously entered account information.

FIG. 6 shows a flow chart of the Group List Subroutine in which a user may either select an existing database, to which a message will be sent, or advance to one of several related subroutines.

FIG. 7 shows a flow chart of the Edit Group List Database Subroutine in which a user may edit or delete any previously entered database information.

FIG. 8 shows a flow chart of the Create New Group List Database Subroutine in which a user creates a new database of numbers and addresses to which messages will be transmitted.

FIG. 9 shows a flow chart of the Event Construction Subroutine through which a user advances to various related subroutines to construct the message and set it's delivery parameters.

FIG. 10 shows a flow chart of the Timed Delivery Subroutine through which the user advances to several related subroutines in order to set the parameters of the message event.

FIG. 11 shows a flow chart, of the Single Message Occurrence Subroutine, in which the user chooses the date and time of delivery for a single message event.

FIG. 12 shows a flow chart, of the Recurring Message Subroutine, in which the user chooses the date, time of delivery and number of recurrences for a recurring message.

FIG. 13 shows a flow chart, of the Message Disposition Subroutine, in which the user makes choices about the number and frequency of retries for a message, if it can be repeated or delivered to an answering device, and the user advances to a related subroutine.

FIG. 14 shows a flow chart, of the Stored Response Setup Subroutine, in which the user chooses to allow or disallow a called party to respond and then advances to related subroutines dependent on the answer.

FIG. 15 shows a flow chart, of the Voice Message Response Capture Subroutine, in which the user chooses to allow a called party to reply to a message with a spoken response.

FIG. 16 shows a flow chart, of the Polling Response Capture Subroutine, in which the user chooses to allow a called party to reply to a message with a polling response (either by entering a touch-tone (digital) reply or speaking a one-word, “Yes” or “No” response).

FIG. 17 shows a flow chart, of the Message Construction Subroutine, in which the user selects a previously created message to be transmitted or advances to one of several related subroutines.

FIG. 18 shows a flow chart, of the Text-to-Speech Conversion Subroutine, in which the user is prompted to choose from a plurality of languages, in which to send the message, and then types in the text of the message.

FIG. 19 shows a flow chart, of the Recorded Message Subroutine, in which the user chooses to either call in on a phone line to record a message or downloads an audio file containing a recorded message.

FIG. 20 shows a flow chart, of the Message Event Log Subroutine, in which the user chooses to receive a log of the message event statistics by one of several methods.

FIG. 21 shows a flow chart, of the Begin/Cancel Event Subroutine, in which the user chooses to accept the message event parameters and begin transmission, cancel an event before transmission begins, or cancel an event in progress.

FIG. 22 shows a flow chart, of the Response Retrieval Subroutine, through which a user may choose to retrieve various types of responses from called parties and may advance to several related subroutines.

FIG. 23 shows a flow chart, of the Polling Response Retrieval Subroutine, through which a user may choose to retrieve stored digital responses by e-mail or fax machine.

FIG. 24 shows a flow chart, of the Audio Response Retrieval Subroutine, through which a user may choose to retrieve stored audio responses by calling a voice mail number or receiving an e-mal.

FIG. 25 shows a flow chart, of the two levels of the Main Marketing Structure for CallMachine.com™.

FIG. 26 shows a flow chart, of the Organizations Subroutine, illustrating the options with which a Governing Organization has to either create a message event itself or to distribute its Affiliation Code to its Affiliate Organizations in order to receive the benefits of the marketing structure.

FIG. 27 shows a flow chart, of the Governing Organization Direct Messaging Subroutine, in which a Governing Organization sends its own message and advances to one of two related marketing structure subroutines.

FIG. 28 shows a flow chart, of the Governing Organization IXC Customer Subroutine, in which the Governing Organization, as a customer of the Inter-Exchange Carrier providing the message delivery function, is billed and may receive discounts or rebates from the IXC and/or CallMachine.com™.

FIG. 29 shows a flow chart, of the Governing Organization Not IXC Customer Subroutine, in which the Governing Organization, is billed and may receive discount or rebates from CallMachine.com™.

FIG. 30 shows a flow chart, of the Affiliated Organization Subroutine, in which an Affiliate Organization uses CallMachine.com™ to send a message and advances to one of two related marketing structure subroutines.

FIG. 31 shows a flow chart, of the Affiliated Organization IXC Customer Subroutine, in which an Affiliated Organization, as a customer of the Inter-Exchange Carrier providing the message delivery function, is billed and they and their Governing Organization may receive discounts or rebates from the IXC and/or CallMachine.com™.

FIG. 32 shows a flow chart, of the Affiliated Organization Not IXC Customer Subroutine, in which an Affiliated Organization is billed and their Governing Organization may receive discounts or rebates from CallMachine.com™.

FIG. 33 shows a flow chart, of the Individual User Subroutine, in which in Individual User uses CallMachine.com™ to send a message and advances to one of two related marketing structure subroutines.

FIG. 34 shows a flow chart, of the Individual User IXC Customer Subroutine, in which an Individual User, as a customer of the Inter-Exchange Carrier providing the message delivery function, is billed and they and may receive discounts or rebates from the IXC.

FIG. 35 shows a flow chart, of the Individual User Not IXC Customer Subroutine, in which an Individual User, is billed.

FIG. 36 shows a flow chart, of the Method for Targeted Advertising, in which the user of CallMachine.com™ is targeted with an advertisement. When a user logs on to any web page within the present invention, a query searches for key words in the information that a user inputs, or has previously input, then related banner advertisements are pulled from a database and placed on the computer screen of the user.

FIG. 37 show the Marketing Method for Banner Advertisements and Co-branding, in which a company or organization may purchase targeted customer specific banner advertisements to appear on the web page of the present invention or may co-brand with said invention so that the web page that a user interacts with appears to be offered by them.

### DETAILED DESCRIPTION OF THE PREFERRED EMBODIMENT

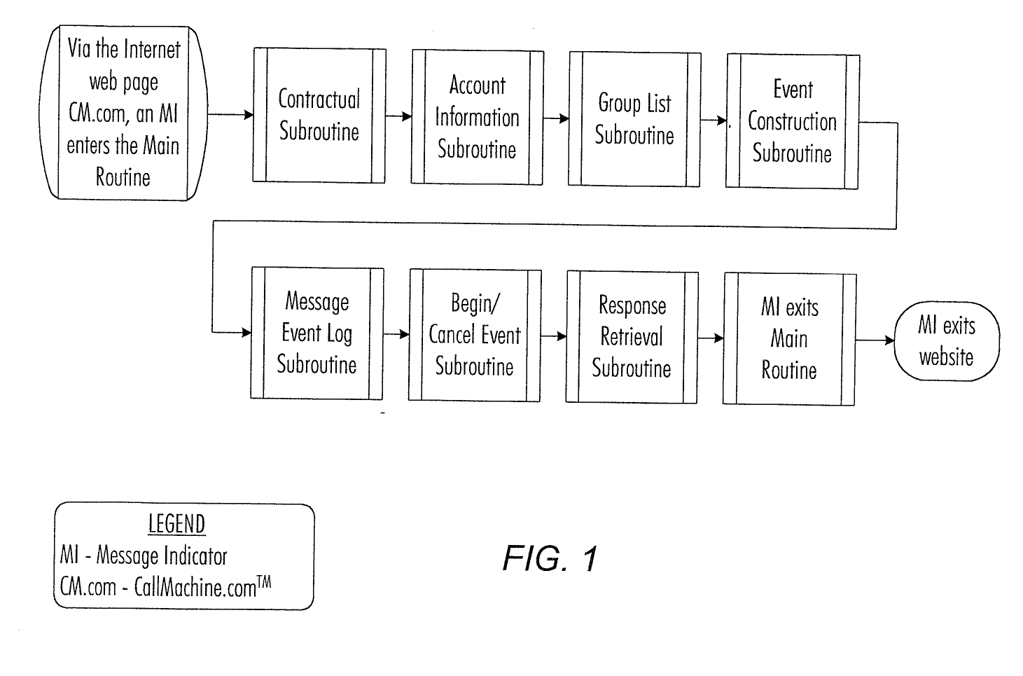

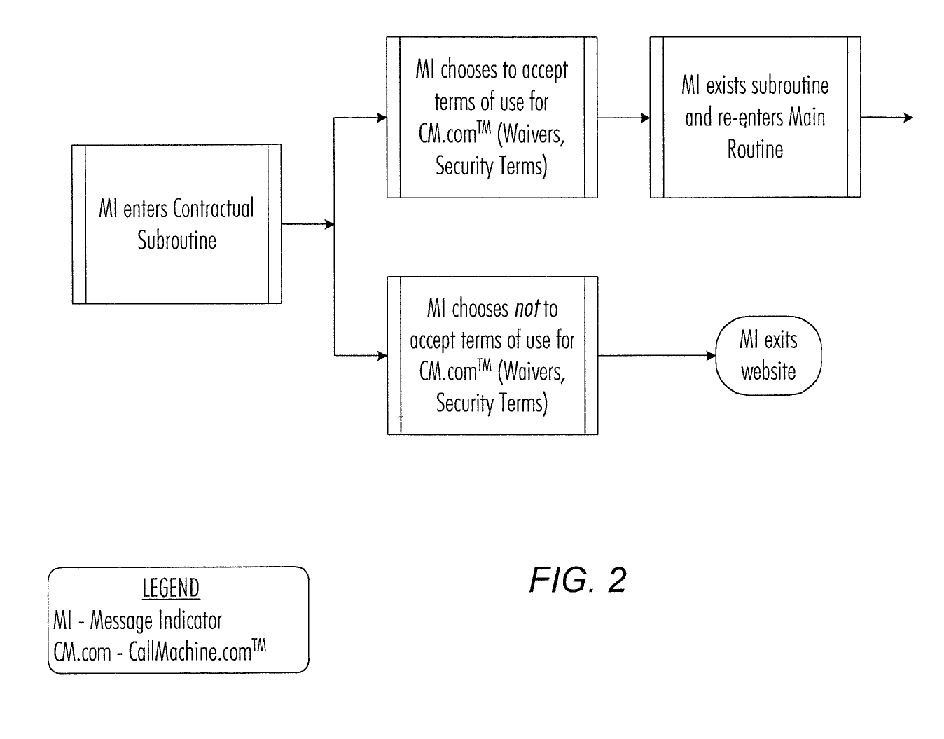

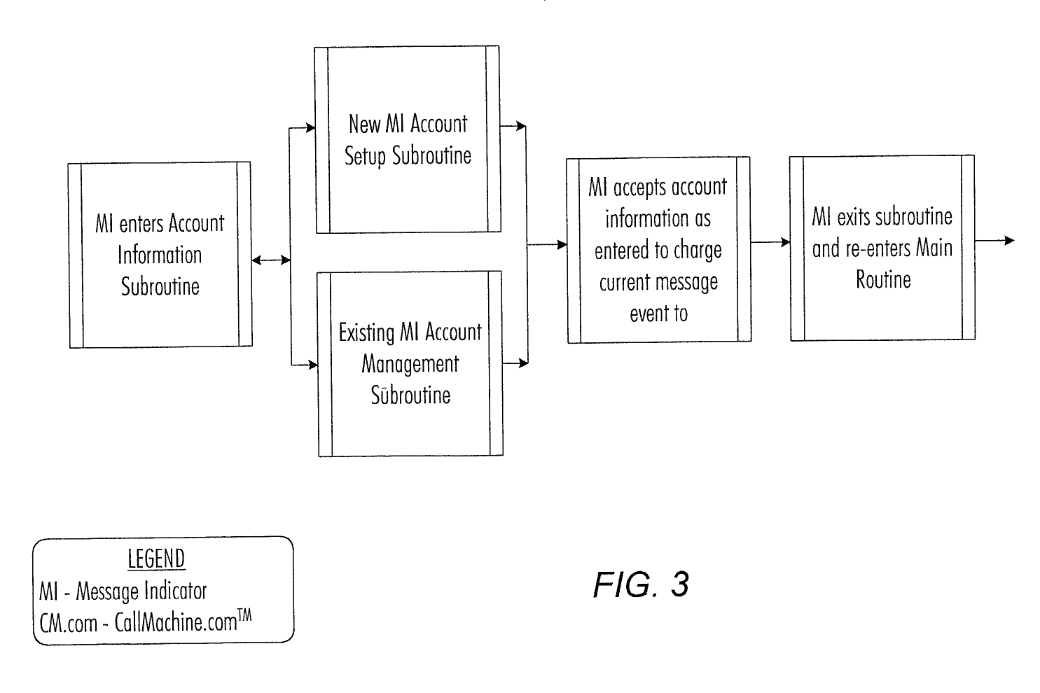

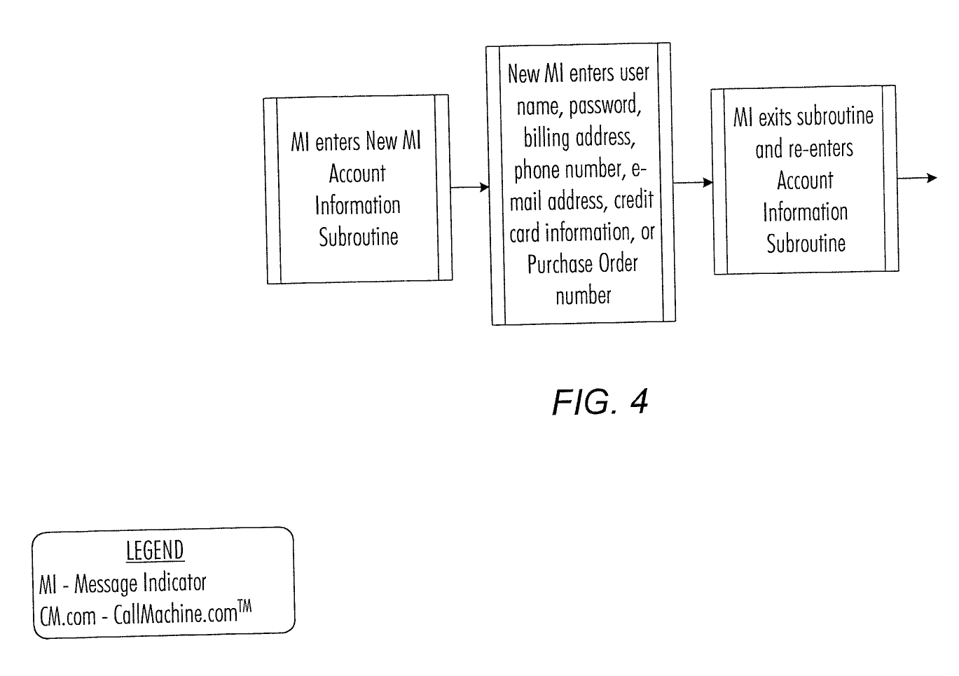

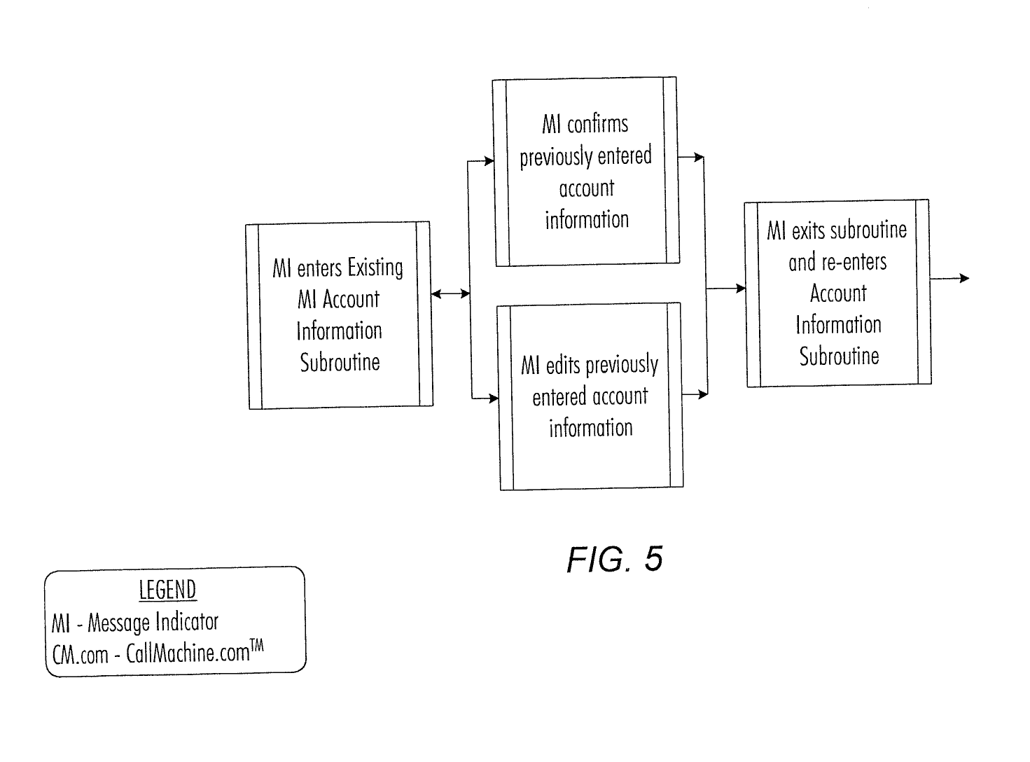

FIG. 1 illustrates the main process of the present invention. A person who wants to send out an automated message enters the web page of the present invention. The user is then prompted by the next step in the process to accept the contractual terms for using the present invention. This is represented in FIG. 2. The next step, shown in FIG. 3, shows that first time users and previous users would enter and/or edit their Account Information for billing and correspondence purposes by following different procedures. Then each would choose to accept the final version of this information. A user who had not previously set up an account would the relevant information including: name, an identifying password, billing address, phone number, e-mail address, credit card information, Purchase Order number and other information about themselves or their organization, as shown in FIG. 4. A user who had an existing account could review their information and/or edit it as shown in FIG. 5.

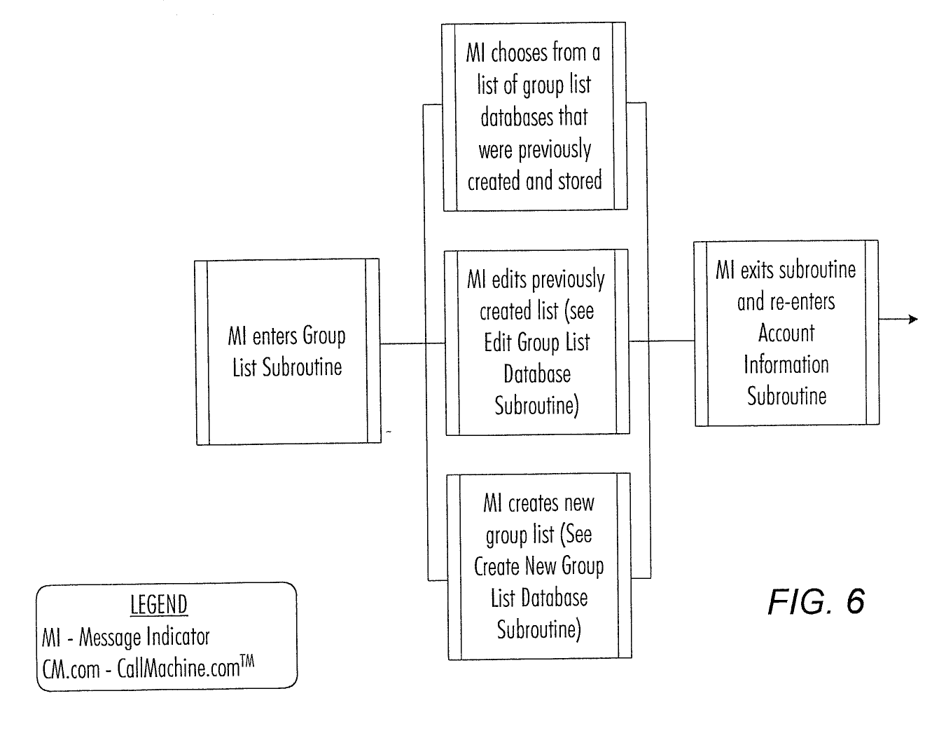

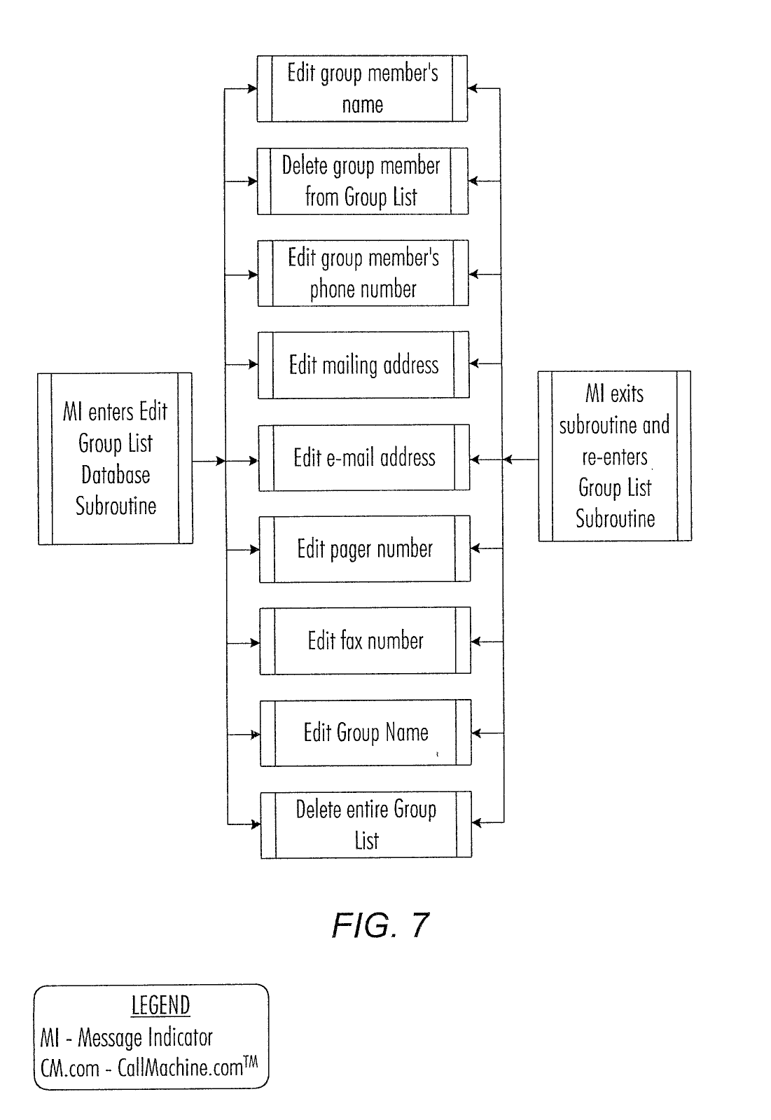

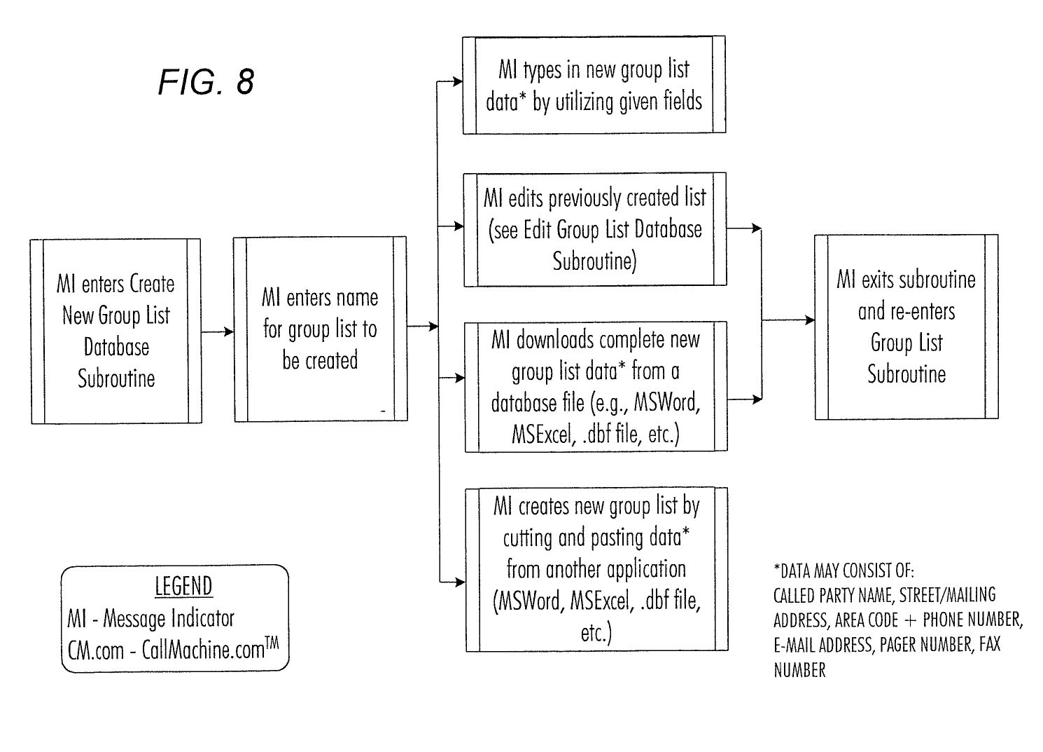

The next step in the process is one in which a user would create, through various methods, the group list databases that will contain the relevant contact information for the individuals to which messages will be sent. This information could include names, phone numbers, mailing addresses, pager numbers, e-mail numbers and fax numbers, etc. FIG. 6 shows that a user has the choice of selecting a previously created database, editing a previously created database or creating a new one. FIG. 7 illustrates how a user may choose to edit any information previously entered into one of the databases that they create. FIG. 8 illustrates how a user may create an entirely new database by one of several means. These means include typing the data into given fields, downloading the data from another application or database file (e.g., MSWord, MSExcel, .dbf file, etc.), cutting & pasting the data from an existing database or cutting and pasting data from another application (e.g., MS Word, MSExcel, .dbf file, etc.).

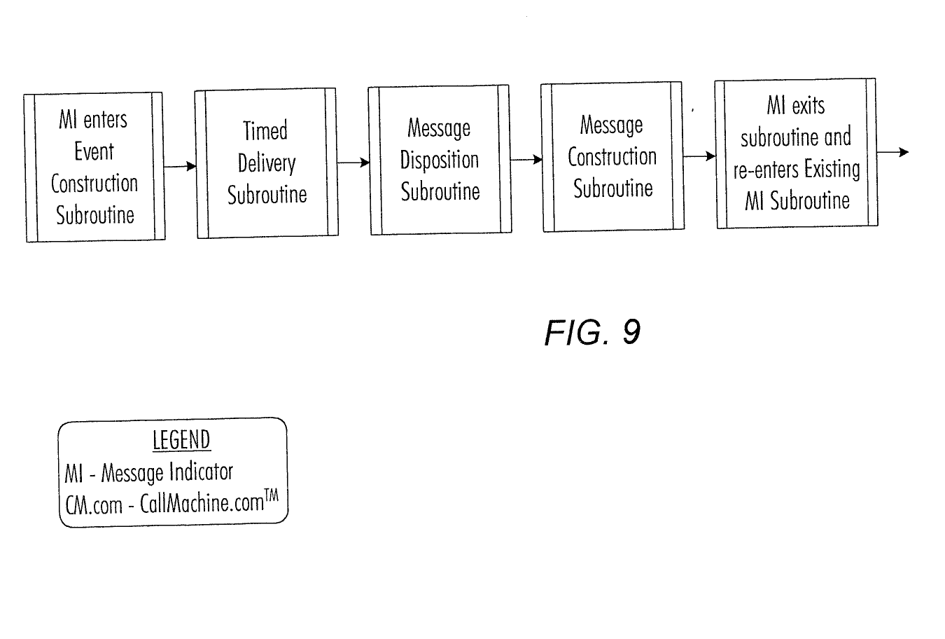

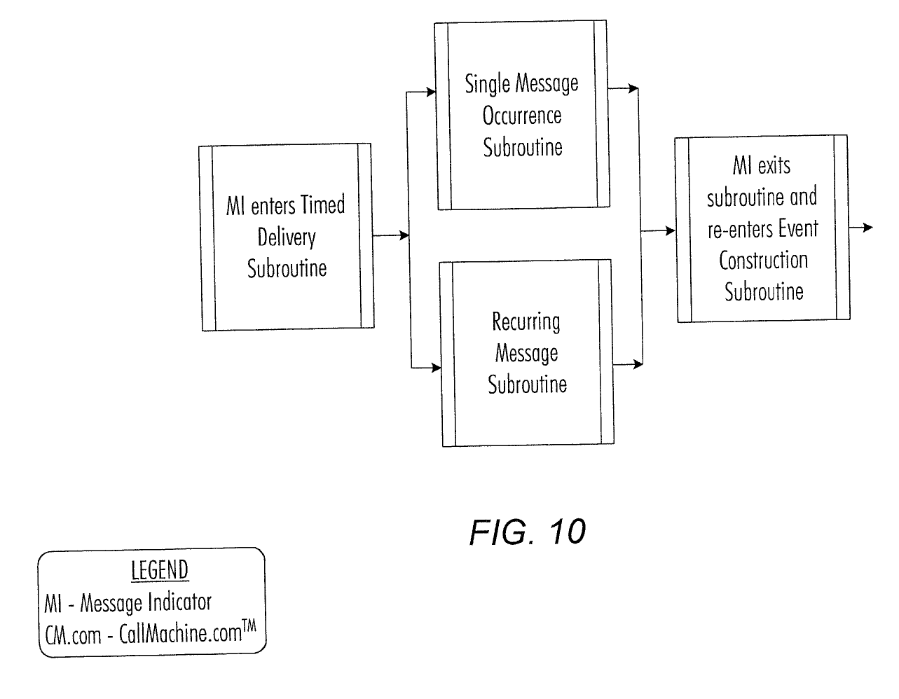

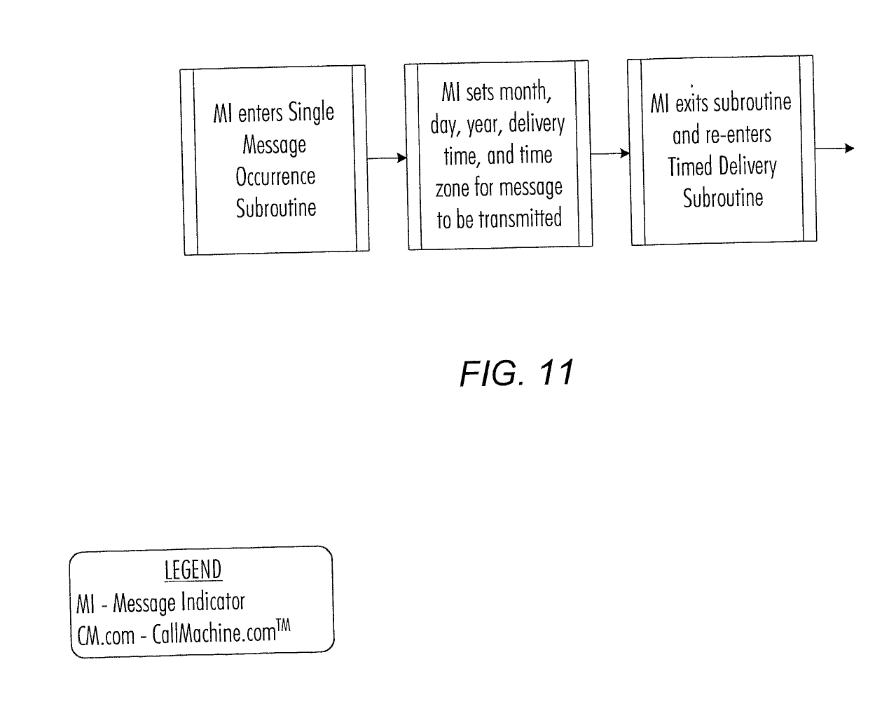

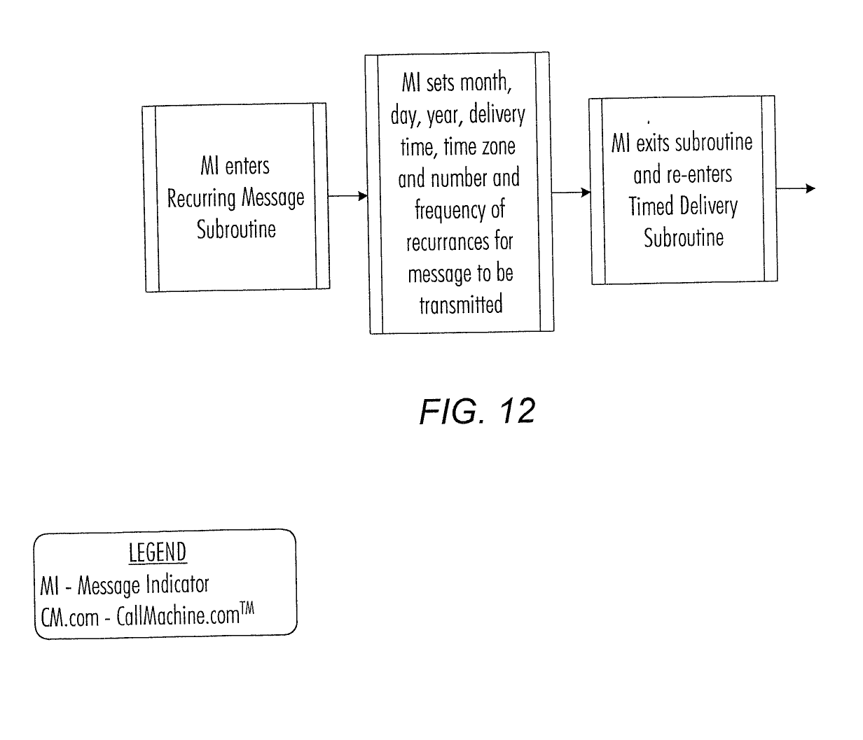

FIG. 9 is an overview of the next subroutines to be followed in order for a user to set the parameters of the message event. FIG. 10 shows the subroutine in which a user is presented with a choice of making a message event a single or a recurring event. If a single event, FIG. 11 shows how the month, day, year, and delivery times (hours of the day) are set by the user. If a recurring event, FIG. 12 shows how said parameters are set by the user as well as the number and frequency of the recurring messages.

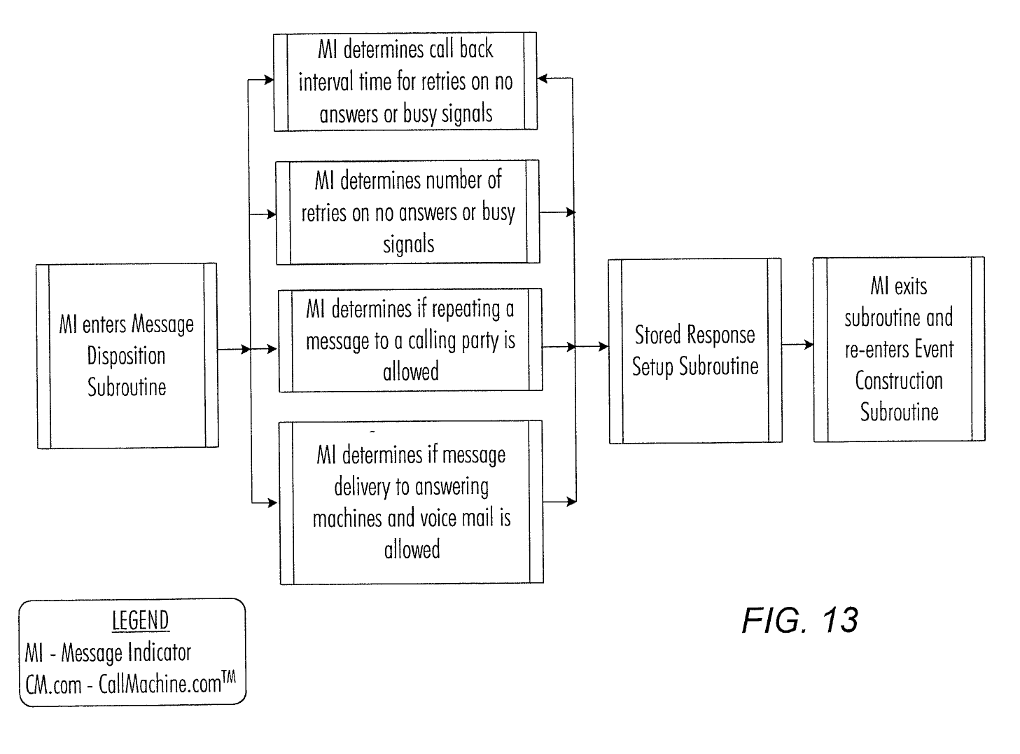

FIG. 13 shows the next set of parameters to be set by the user in which it is determined how many times a message will be transmitted if a busy or no answer signal is encountered.

Also selected are the time frames for the retries, if a called party is allowed to hear the message more than once, and if a message can be left on a voice mail or answering machine. Also, shown in this illustration is a subroutine allowing a user to allow or disallow a called party to respond to the message sent.

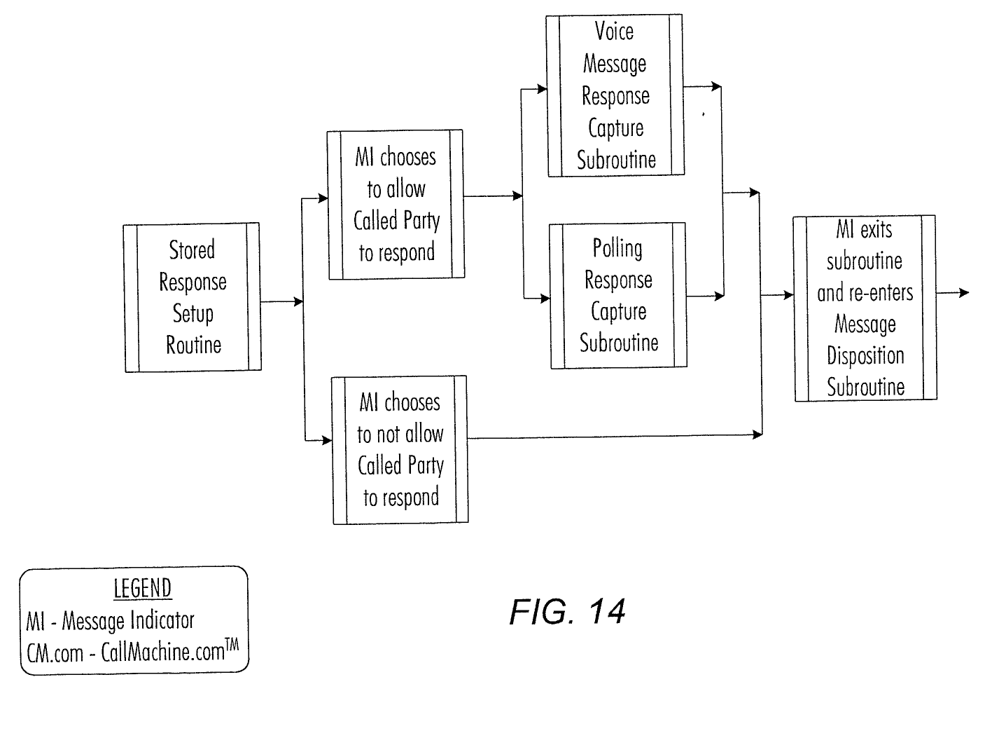

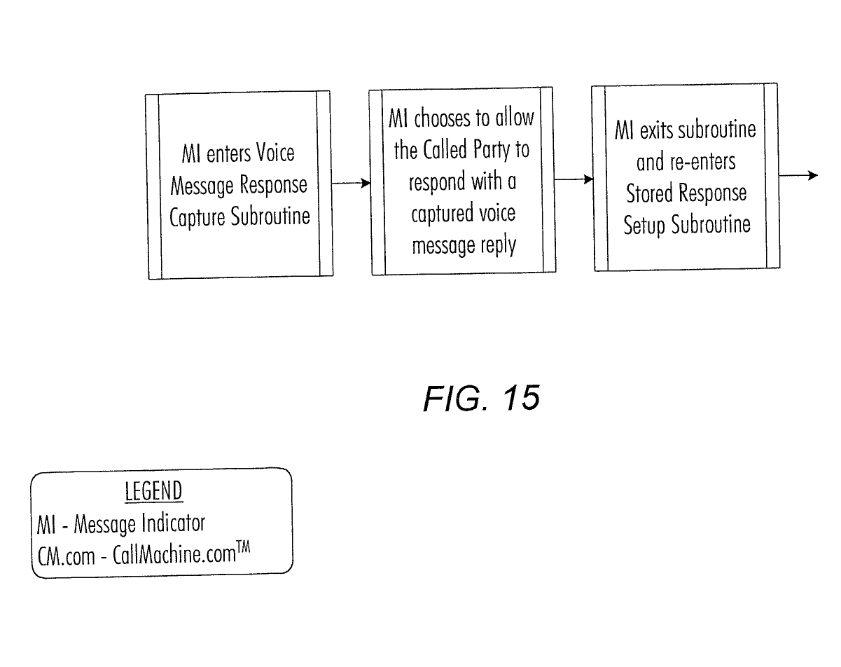

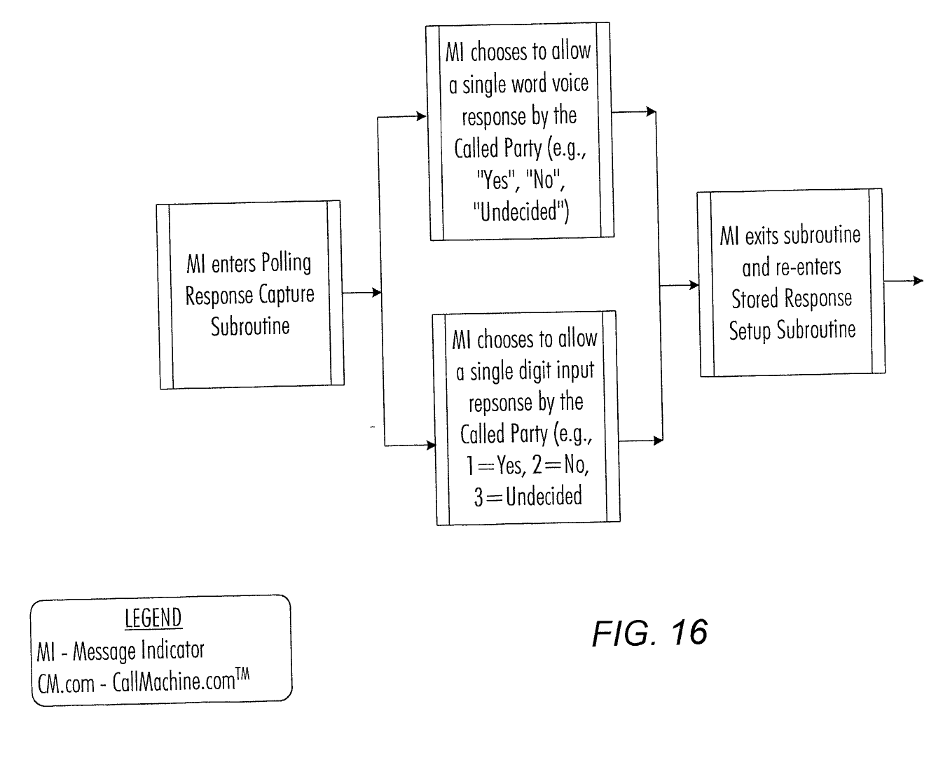

FIG. 14 shows a subroutine in which a user may choose to allow or disallow a called party to respond to a message that was sent and then advances to related subroutine to set the parameters for those responses. FIG. 15 shows one of the choices a user has to allow a voice message response to a sent message that is composed of more than one word. Another choice is shown in FIG. 16 in which the user allows the called party to respond with the input of a one-word response or a touch-tone (digital) reply. These responses are then compiled, analyzed and stored for later retrieval by the user.

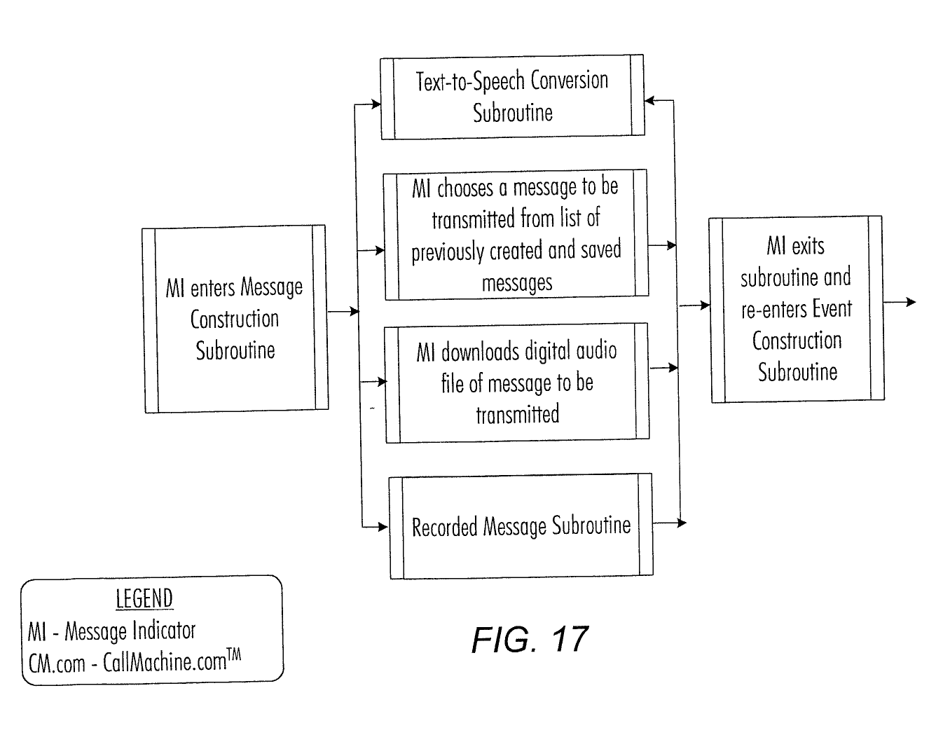

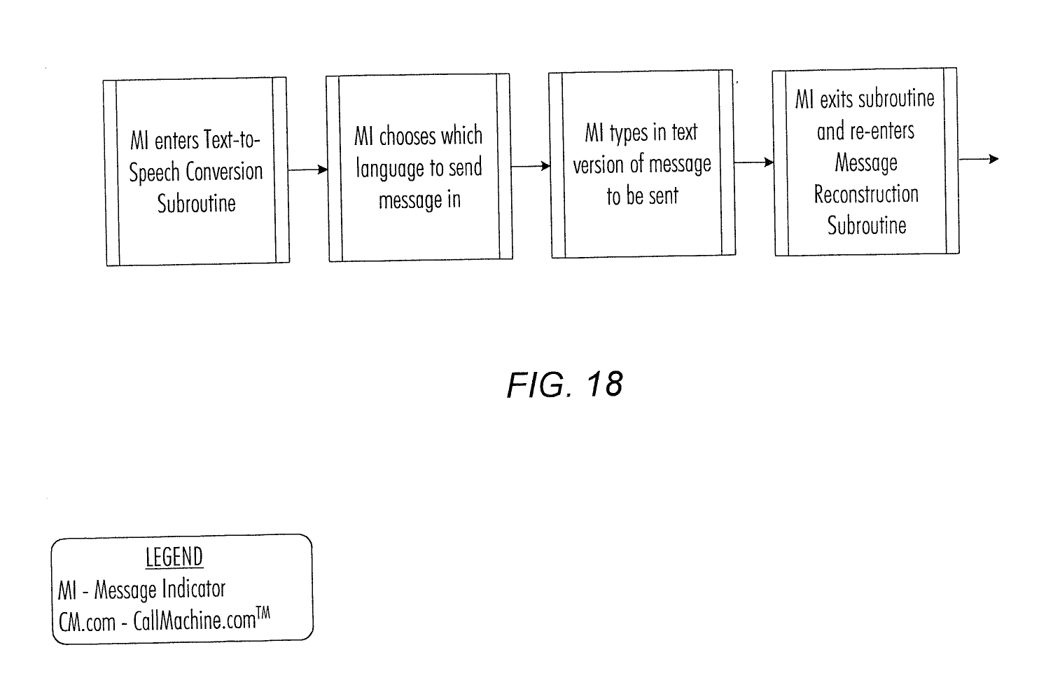

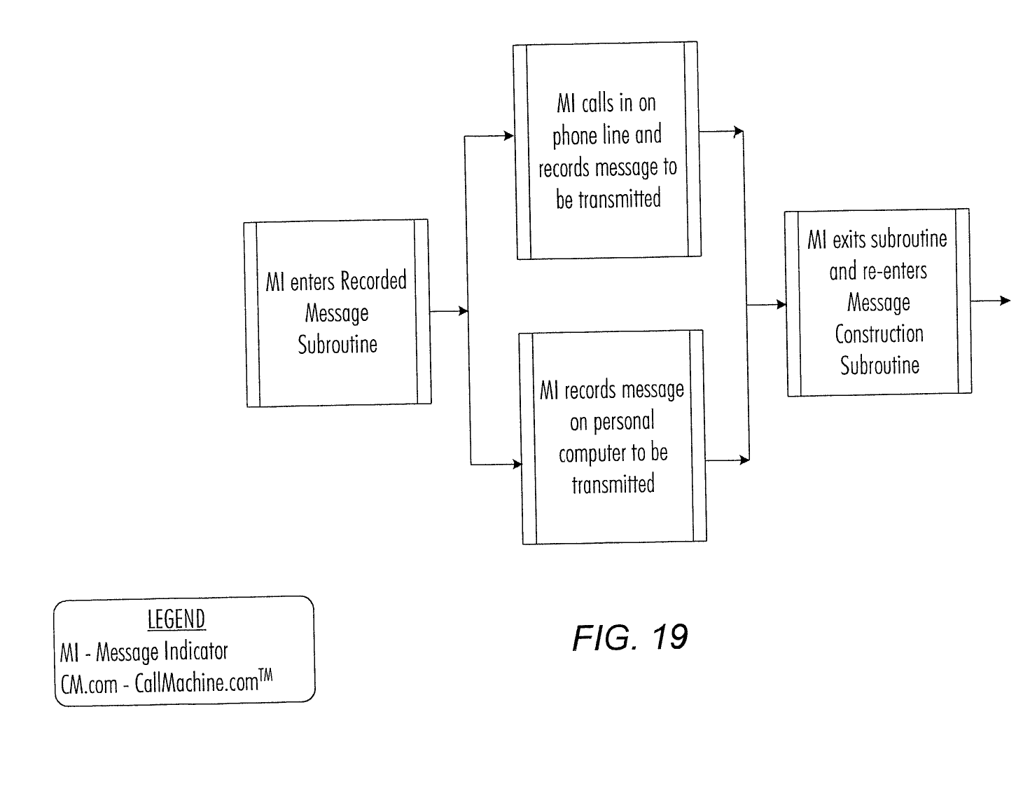

In order to construct a message to be sent a user would begin by following the process shown in FIG. 17. The user has a choice of whether to select a previously created and stored message, to download an audio file of a message, or to create new messages by either typing in the text of the message or recording one. FIG. 18 shows the process by which a user would create a message by choosing which language to transmit it in and then typing the message text into a given field on the web page. The text that is entered would then be converted in to speech in order to be transmitted over outgoing phone lines and stored for subsequent use. FIG. 19 shows an alternate method for creating a message by calling in on a phone number that is provided and recording a voice message to be transmitted or by creating a voice message on the users owns personal computer which will be transmitted.

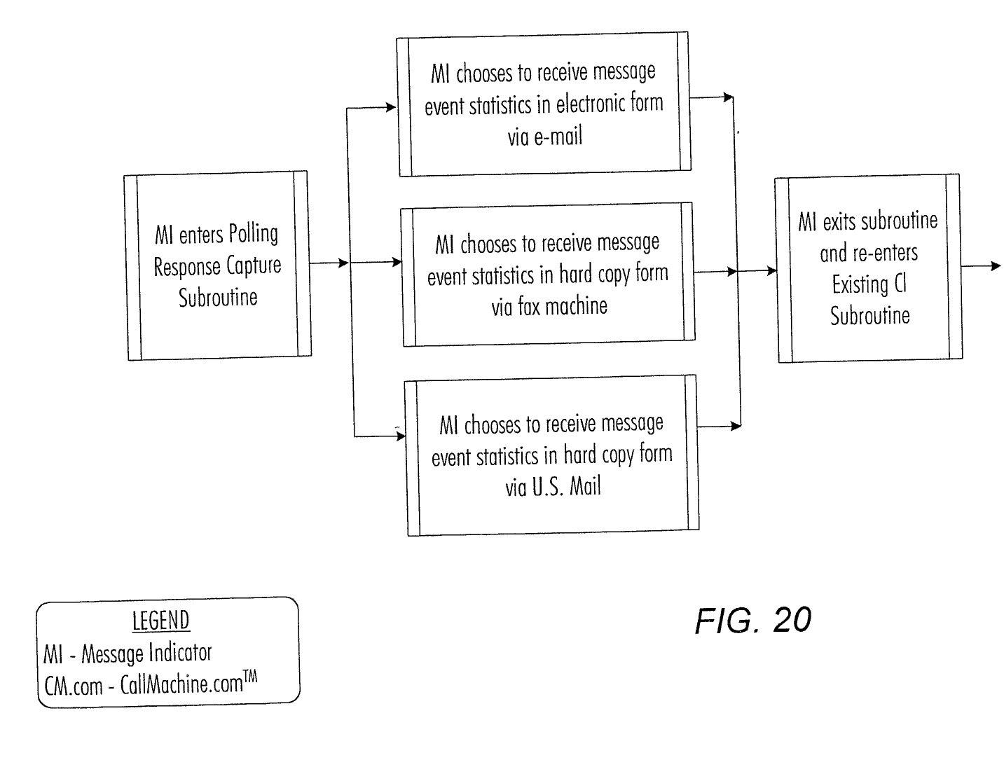

There are several methods my which a user may receive a log which gives them the details concerning their message transmission. These details may include which numbers in the database were or were not contacted, how many calls to each number were made and when, if a message was left on a voice mail system or answering machine and how many no answers, busy signals or fax machines were encountered. FIG. 20 shows that these statistics may be requested by the user in electronic form via e-mail or hard copy form via fax machine or via the U.S. Postal Service.

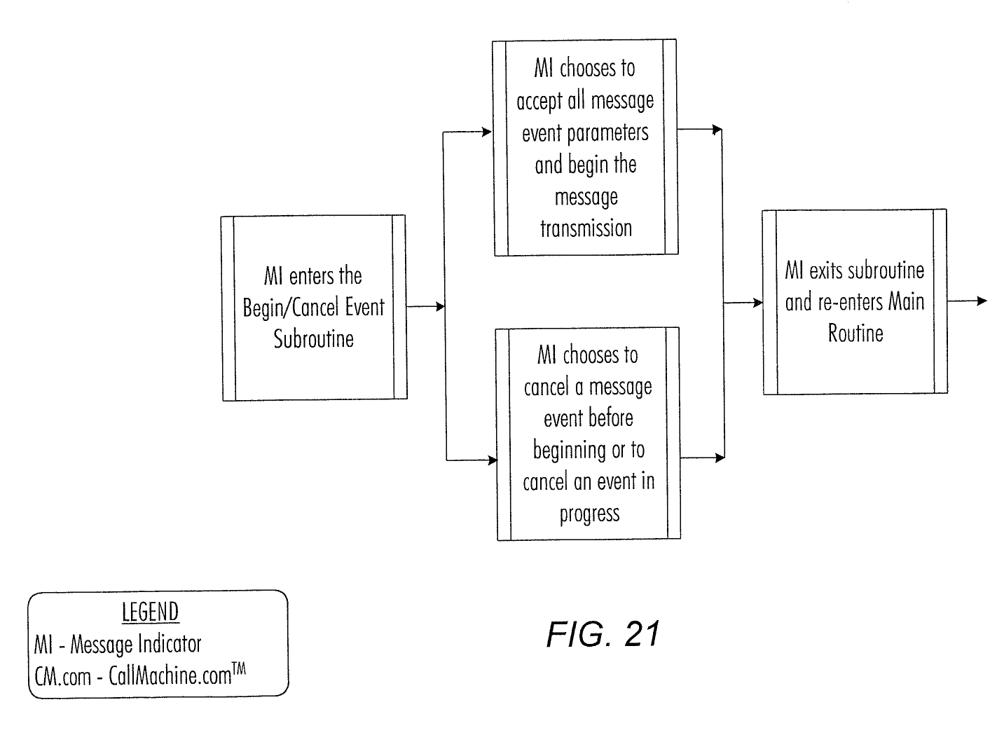

As shown is FIG. 21, once the message has been created and its parameters set, the next step is for the user to then choose to set the event in motion. The user may also choose to clear out the settings for the event and cancel it before it begins or cancel an event already in progress.

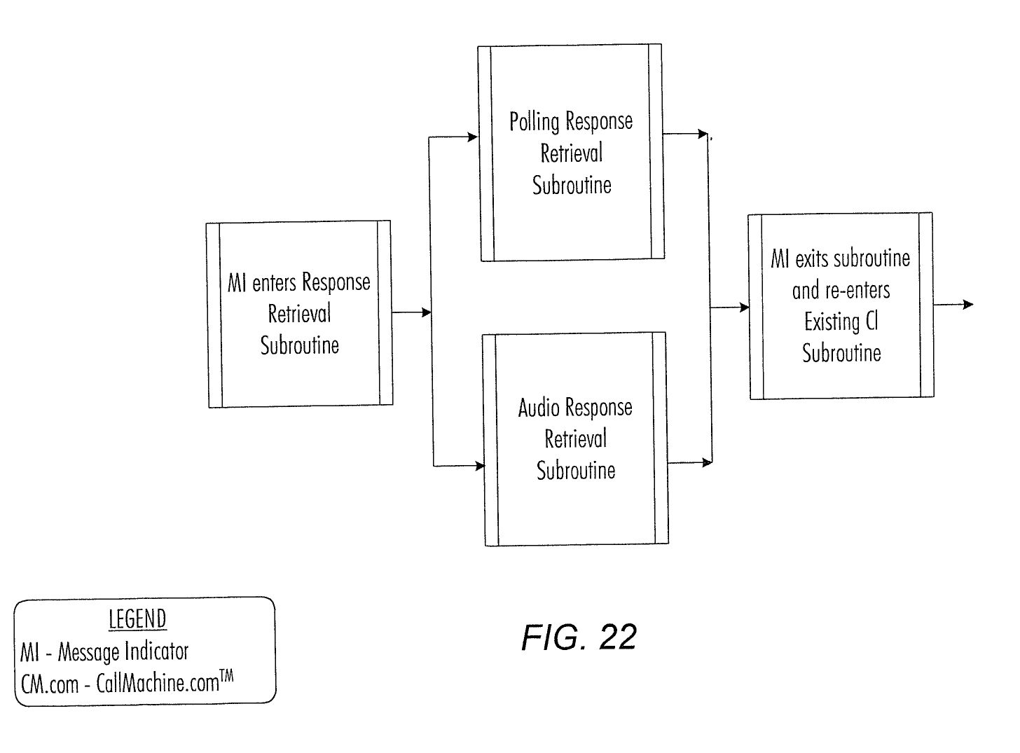

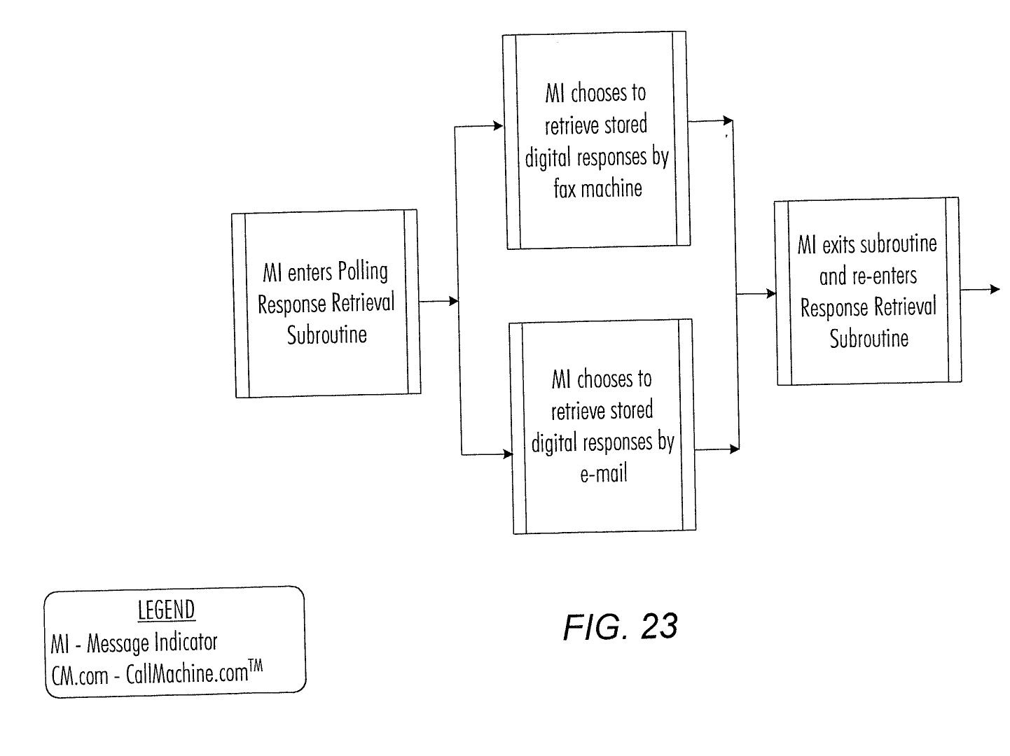

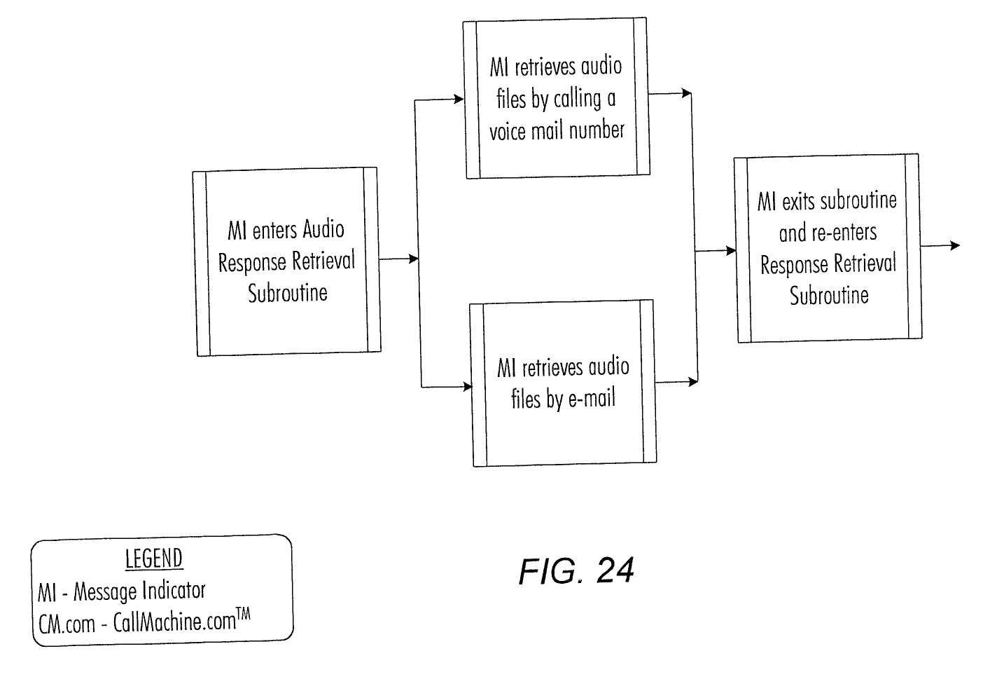

Once the message has been sent, a user is given the option of retrieving whatever responses the called parties have entered in reply. FIG. 22 shows the two subroutines to which a user may advance in order to retrieve responses. FIG. 23 shows how a user may retrieve stored digital (touch-tone) responses or one-word voice responses by fax machine or e-mail. FIG. 24 shows how a user may retrieve stored voice responses (longer than one-word) by calling into a designated voice mail number or by receiving audio files by e-mail.

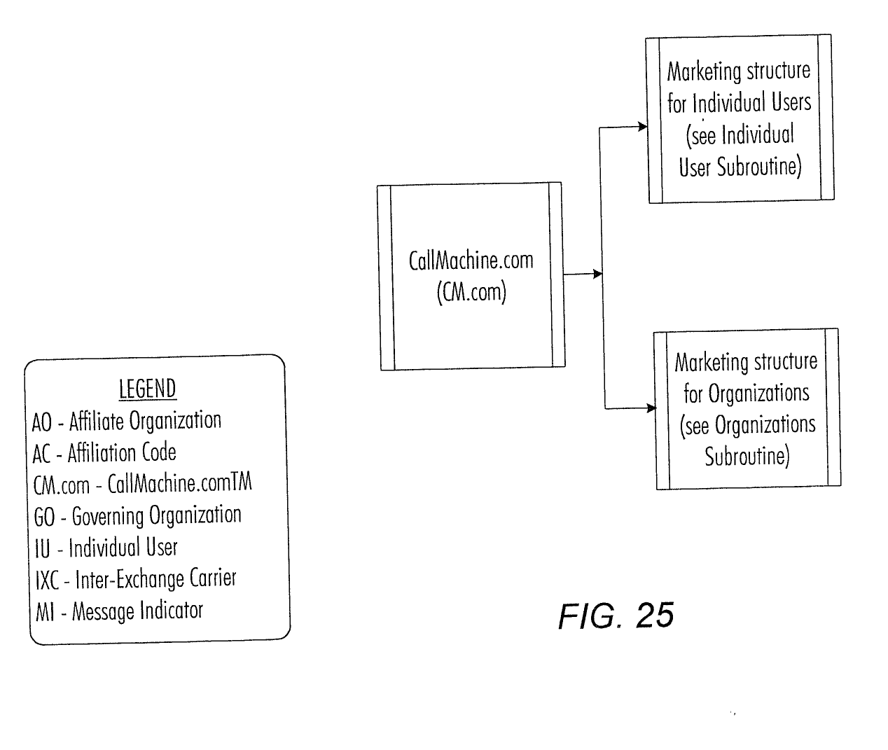

One aspect of the present invention relates to a marketing method. The unique marketing method for the present invention combines an automated outbound message delivery method with an Internet based marketing and referral fee program for users. FIG. 25, shows that the present invention has separate Internet based marketing methods for differing types of users. Governing Organizations that have Affiliated Organizations under their purview are offered an incentive for registering with and encouraging their Affiliated Organizations to utilize the present invention in order that both they and their Affiliate Organizations may receive incentives such as discounts, rebates or free service, etc. These incentives may come from the present invention or the Inter-Exchange Carrier that is carrying out the message delivery function.

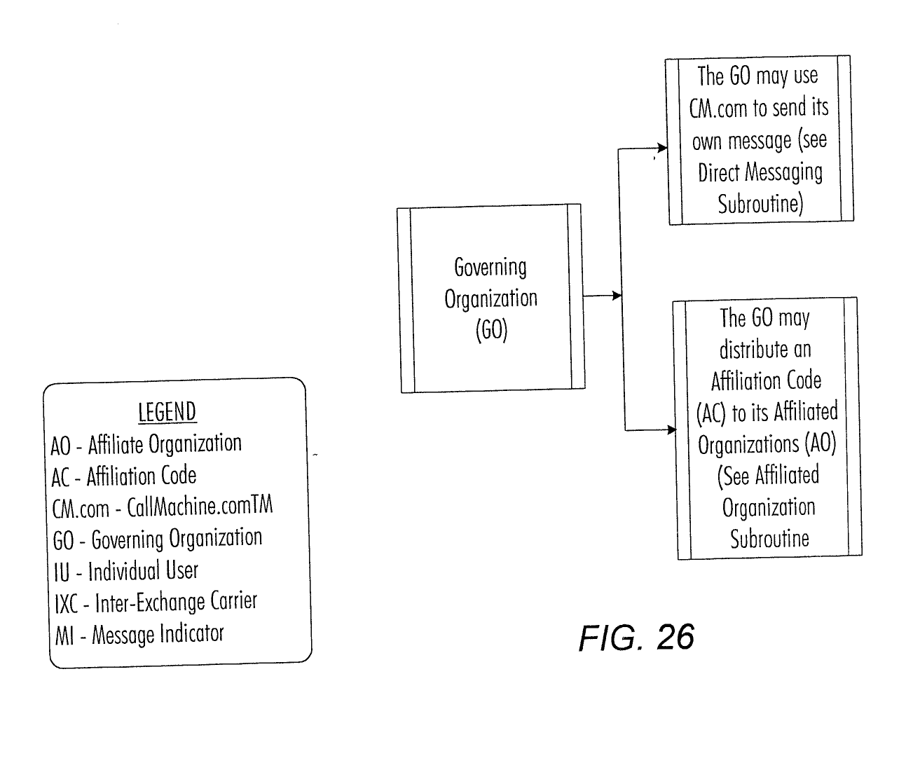

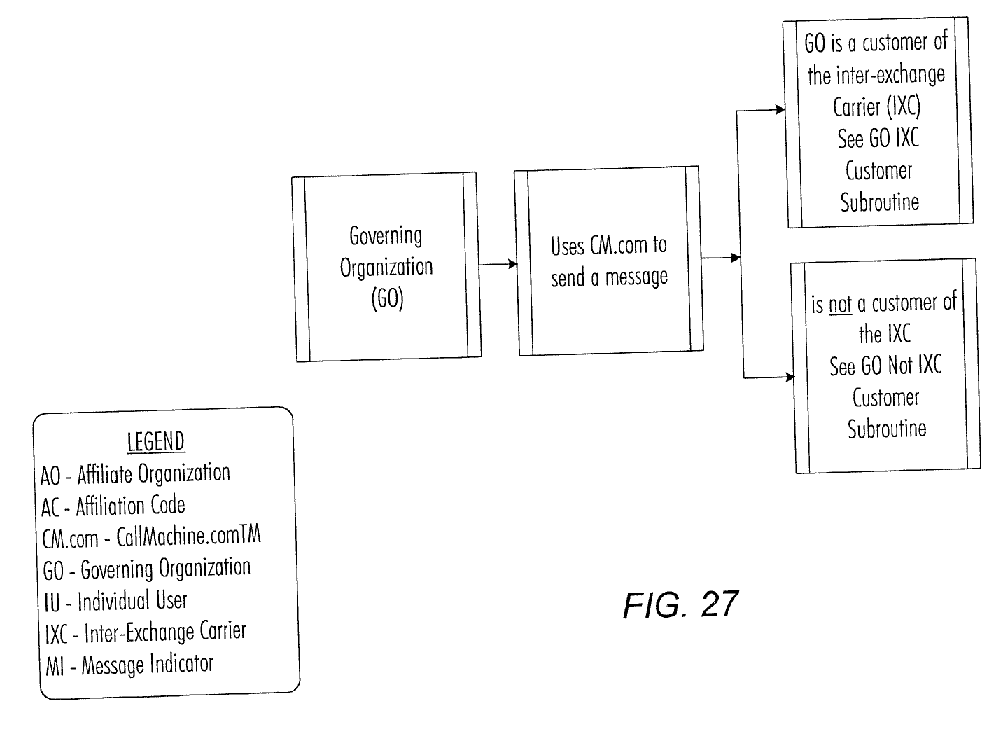

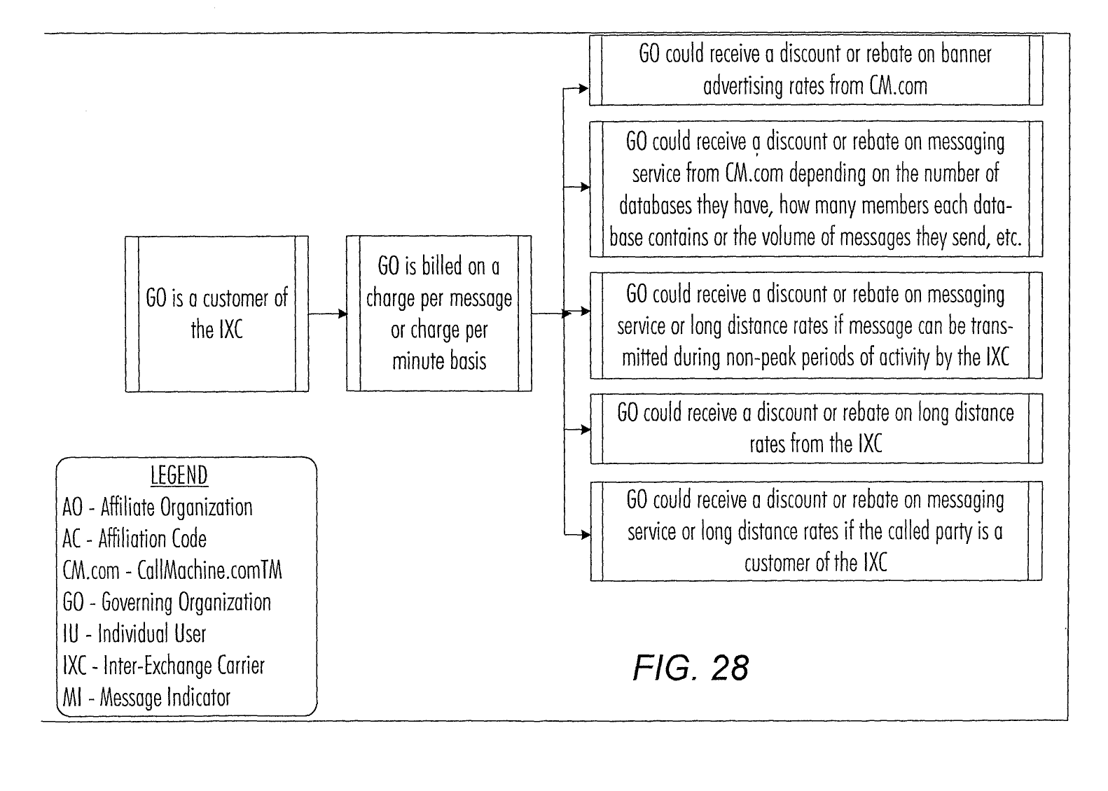

FIG. 26 shows that a Governing Organization may either use the present invention to send an automated message for its own purposes or, once it is registered with the service, may pass on its Affiliation Code to its Affiliated Organizations for them to use. If an Affiliated Organization utilizes this Code when sending a message then the Governing Organization may receive benefits from that event. FIG. 27 shows that if a Governing Organization uses the present invention to send a message itself, it will receive benefits, some of which are based upon whether it is or is not a customer of the Inter-Exchange Carrier that is carrying out the message delivery function. FIG. 28 shows that an organization is billed on a per message or per minute basis and, if a customer of the Inter-Exchange Carrier, may receive various combinations of incentives in the following forms:

a discount or rebate on message service or long distance rates

a discount or rebate on the message service based on the number of databases an organization has, the number of members in the databases and/or the volume of messages that are sent

a discount or rebate on banner advertising rates that may be placed on the web pages of the present invention

a discount or rebate on message service or long distance rates if the user will allow the message to be transmitted during non-peak periods of activity for the Inter-Exchange Carrier carrying out the message delivery function

a discount or rebate on message service or long distance rates if the called party is a customer of the Inter-Exchange Carrier

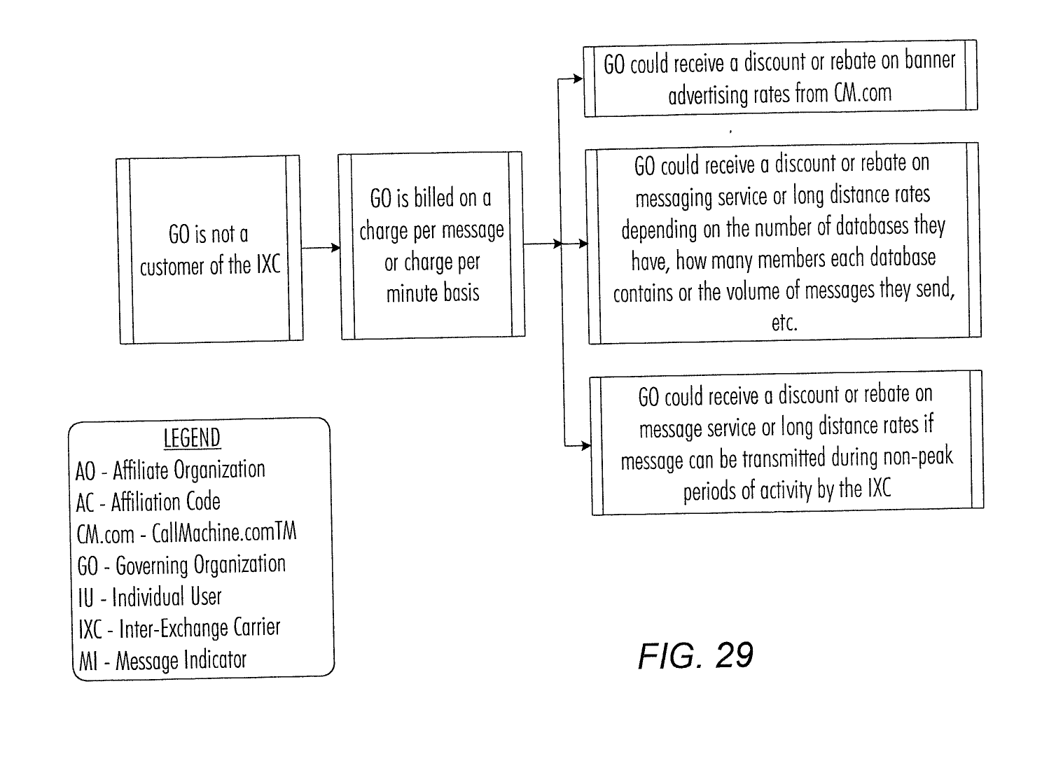

If the Governing Organization is not a customer of the Inter-Exchange Carrier, then it may receive various combinations of incentives in the following forms as shown in FIG. 29:

a discount or rebate on the message service based on the number of databases an organization has, the number of members in the databases and/or the volume of messages that are sent

a discount or rebate on banner advertising rates that may be placed on the web pages of the present invention

a discount or rebate on message service or long distance rates if the user will allow the message to be transmitted during non-peak periods of activity for the Inter-Exchange Carrier carrying out the message delivery function

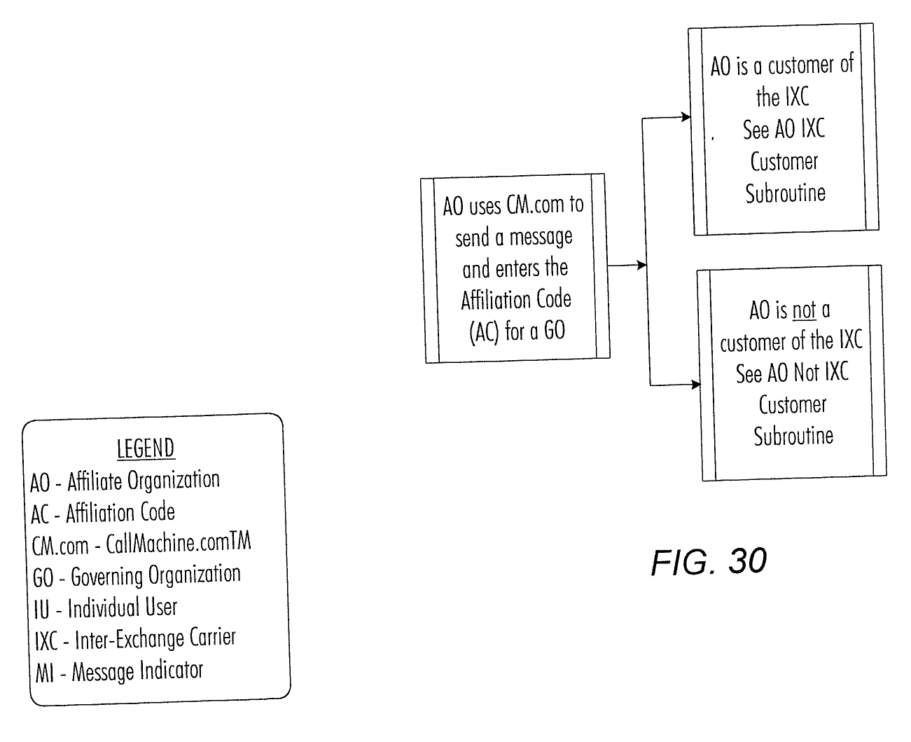

There are benefits to be gained by the Governing Organization if they distribute their Affiliation Code to their Affiliate Organizations and encourage them to utilize it when send a message via the present invention. FIG. 30 shows that if an Affiliate Organization uses the present invention to send a message, it and its Governing Organization may receive benefits.

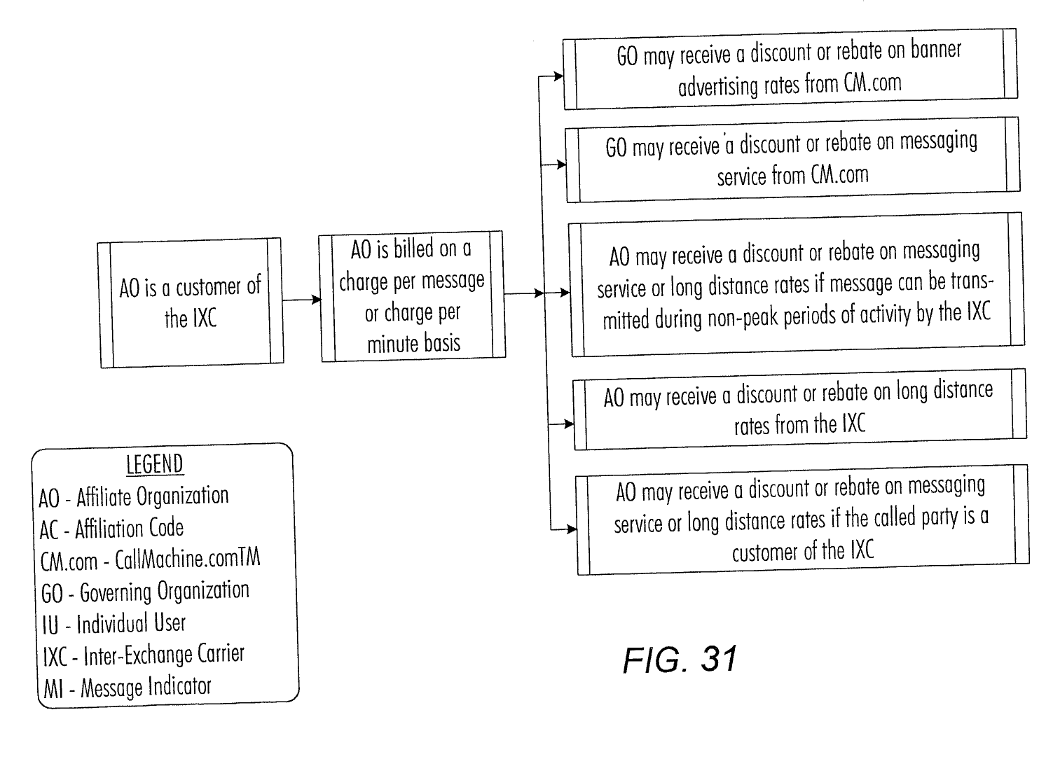

Some of these benefits are based upon whether the Affiliate Organization is or is not a customer of the Inter-Exchange Carrier that is carrying out the message delivery function. FIG. 31 shows that an Affiliate Organization is billed on a per message or per minute basis. If it is a customer of the Inter-Exchange Carrier it and its Governing Organization may receive various combinations of incentives in the following forms:

The Governing Organization may receive a discount or rebate on its message service based on the number of databases the Affiliated Organization has, the number of members in the databases and/or the volume of messages that are sent

The Governing Organization may receive a discount or rebate on banner advertising rates that may be placed on the web pages of the present invention

The Affiliated Organization may receive a discount or rebate on message service or long distance rates

The Affiliated Organization may receive a discount or rebate on message service or long distance rates if the user will allow the message to be transmitted during non-peak periods of activity for the Inter-Exchange Carrier carrying out the message delivery function

The Affiliated Organization may receive a discount or rebate on message service or long distance rates if the called party is a customer of the Inter-Exchange Carrier

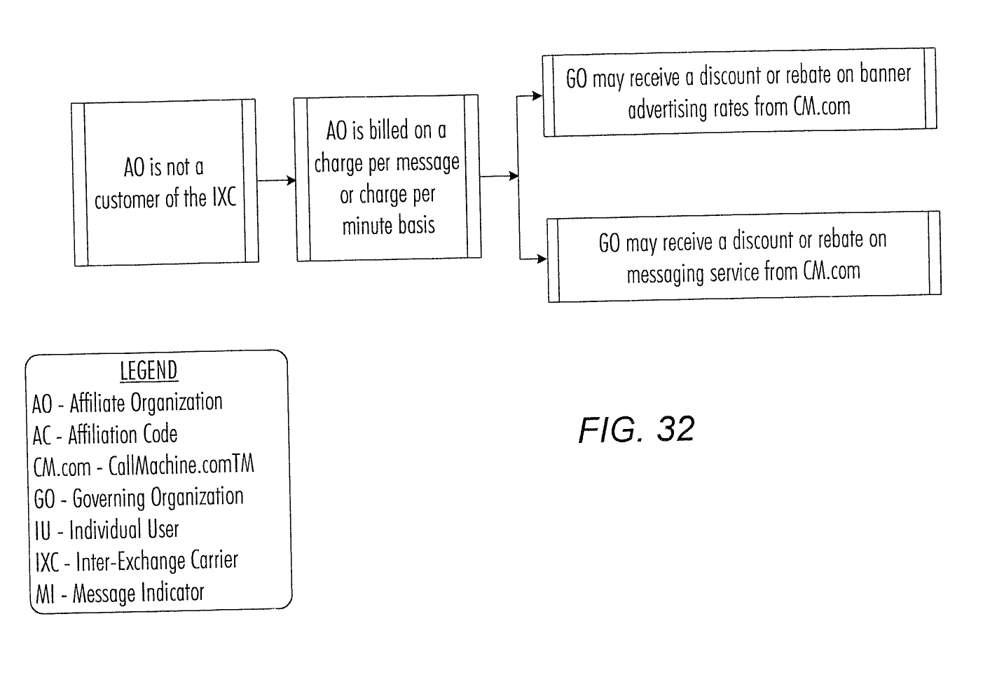

If the Affiliated Organization is not a customer of the Inter-Exchange Carrier, then its Governing Organization may receive various combinations of incentives in the following forms as shown in FIG. 32:

a discount or rebate on message service based on the number of databases an organization has, the number of members in the databases and/or the volume of messages that are sent

a discount or rebate on banner advertising rates that may be placed on the web pages of the present invention

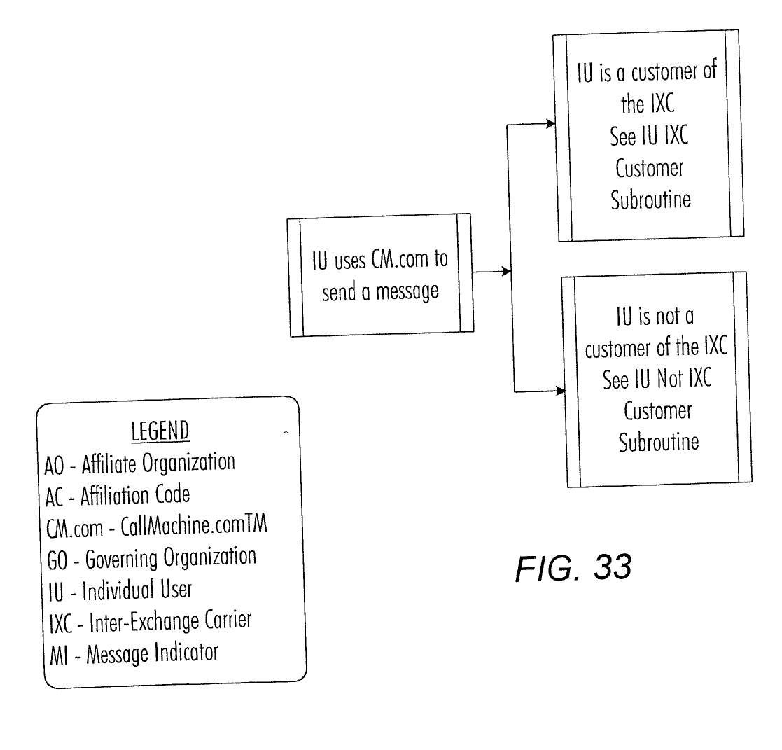

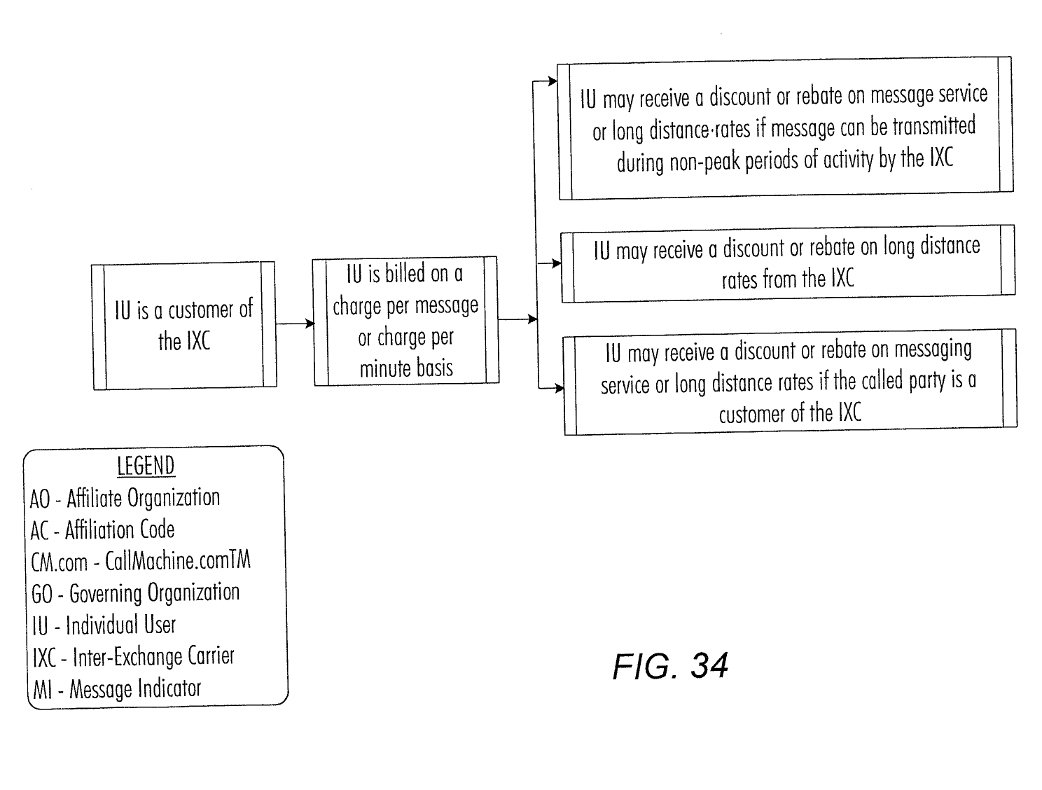

When an Individual User send a message by the present invention he or she may 15 receive benefits. Some of these benefits are based upon whether the user is or is not a customer of the Inter-Exchange Carrier that is carrying out the message delivery function as shown in FIG. 33. FIG. 34 shows that an Individual User is billed on a per message or per minute basis and if a customer of the Inter-Exchange Carrier may receive various combinations of incentives in the following forms:

a discount or rebate on message service or long distance rates

a discount or rebate on message service or long distance rates if the user will allow the message to be transmitted during non-peak periods of activity for the Inter-Exchange Carrier carrying out the message delivery function

a discount or rebate on message service or long distance rates if the called party is a customer of the Inter-Exchange Carrier

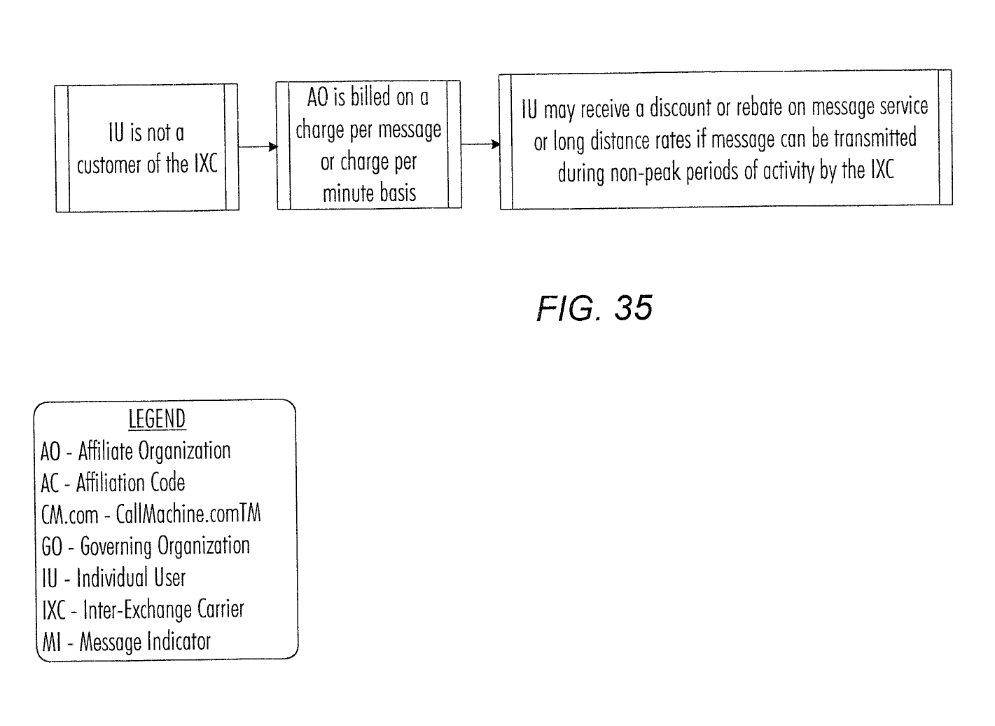

If not a customer of the Inter-Exchange Carrier, the Individual User is billed on a charge per message or charge per minute basis and may receive a discount or rebate on message service or long distance rates if the user will allow the message to be transmitted during non-peak periods of activity for the Inter-Exchange Carrier carrying out the message delivery function as shown in FIG. 35.

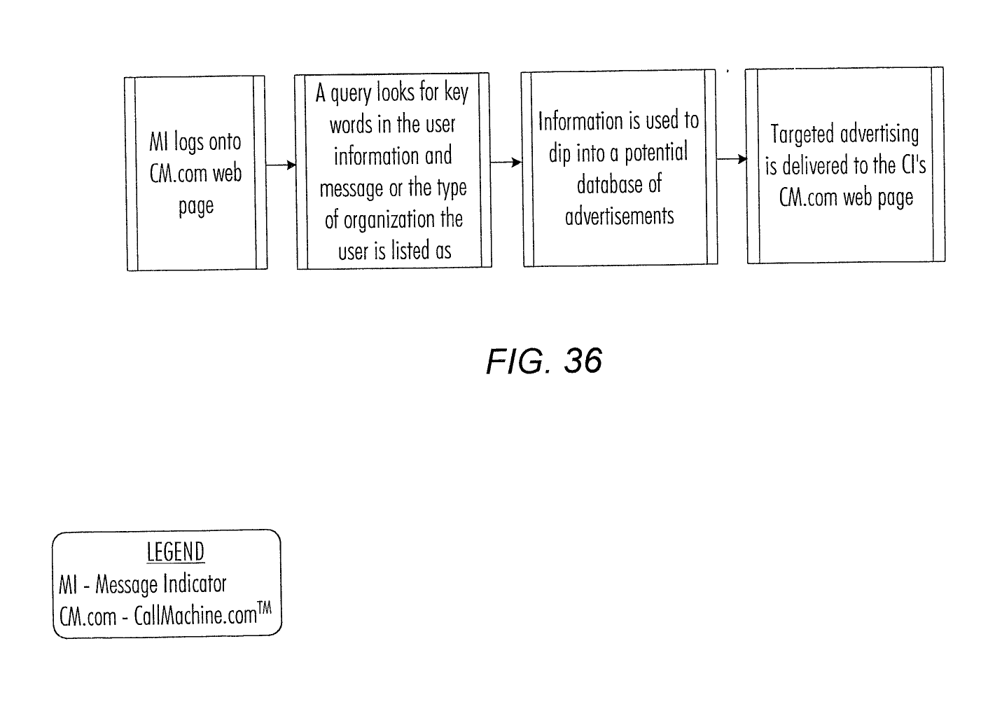

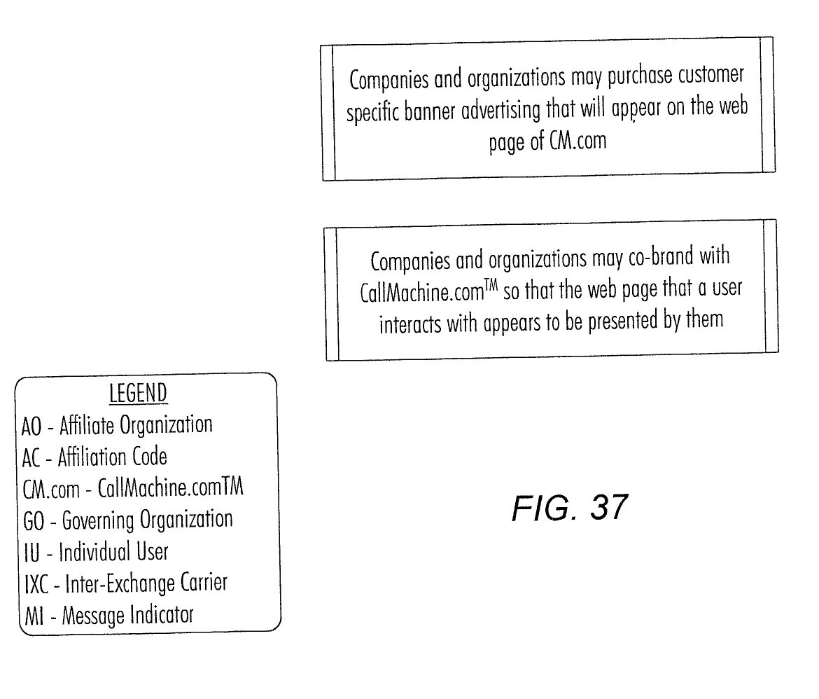

FIG. 36 illustrates the Method for Targeted Advertising of the present invention. When a user logs on to any web page within the present invention, a query searches for key words in the information that a user inputs, or has previously input, then related banner advertisements are pulled from a database and placed on the computer screen of the user. FIG. 37 illustrates the Marketing Method for Banner Advertisements and Co-branding. A company or organization may purchase targeted customer specific banner advertisements to appear on the web page of the present invention. They may also co-brand with said invention so that the web page that a user interacts with appears to be offered by them.

The present invention also includes various other combinations, including the following:

a combination of an automated outbound message delivery method with the means for editing a previously entered database;

a combination of an automated outbound message delivery method with the means for accessing previously entered databases in order to transmit a previously stored message on an outgoing phone line;

a combination of an automated outbound message delivery method with the means for selecting a day, month and year for a stored message to be transmitted to a database;

a combination of an automated outbound message delivery method with the means for

selecting a time of day for a stored message to be transmitted to a database;

a combination of an automated outbound message delivery method with the means for selecting the number of stored message transmission attempts to be made upon receipt of a busy, no answer, or fax signal;

a combination of an automated outbound message delivery method with the means for creating a recurring message event and predetermining the parameters of said event;

a combination of an automated outbound message delivery method with the means for entering a text message to be stored and converted to speech to be transmitted over an outgoing phone line to a database;

a combination of an automated outbound message delivery method with the means for entering a text message, in a plurality of languages, to be stored and converted to speech to be transmitted over an outgoing phone line to a database;

a combination of an automated outbound message delivery method with the means for recording a voice message on-line to be stored and transmitted over an outgoing phone line to a database;

a combination of an automated outbound message delivery method with the means for downloading a digital audio file to be stored and transmitted over an outgoing phone line to a database,

a combination of an automated outbound message delivery method with the means for editing a stored message to be transmitted over an outgoing phone line to a database of phone numbers;

a combination of an automated outbound message delivery method with the means for playing a stored message, after the outgoing phone call connection has been established, to a database;

a combination of an automated outbound message delivery method with the means for playing a stored message upon connection to a voice mail system or answering machine;

a combination of an automated outbound message delivery method with the means for prompting the called party, by playing a stored message, after the outgoing connection has been established, to enter one of a plurality of different dial code responses;

a combination of an automated outbound message delivery method with the means for prompting the called party, by playing a stored message, after the outgoing connection has been established, to enter one of a plurality of voice responses;

a combination of an automated outbound message delivery method with the means for recording a touch-tone (digital) response entered by a called party;

a combination of an automated outbound message delivery method with the means for recording an audio response entered by a called party;

a combination of an automated outbound message delivery method with the means for compiling and analyzing and retrieving stored audio and touch-tone (digital) responses;

a combination of an automated outbound message delivery method with the means for delivering stored audio and touch-tone (digital) responses and their analysis entered by a called party through facsimile or e-mail, or retrieval over the Internet;

a combination of an automated outbound message delivery method with the means for retrieving stored audio responses entered by a called party by voice mail, e-mail, or retrieval over the internet;

a combination of an automated outbound message delivery method with the means for requesting and receiving an electronic version of a log indicating the success or failure of the call connections in a messaging event;

a combination of an automated outbound message delivery method with the means for delivering an electronic version of a log indicating the success or failure of the connections in a messaging event;

a combination of an automated outbound message delivery method with the means for requesting and receiving a paper copy version of a log indicating the success or failure of the connections in a messaging event.

While various embodiments of the present invention have been described in detail, it is apparent that further modifications and adaptations of the invention will occur to those skilled in the art. However, it is to be expressly understood that such modifications and adaptations are within the spirit and scope of the present invention.

What is claimed is:

1. An automated outbound message delivery system for transmitting outbound messages comprising:
a means for creating a database having information selected from the group consisting of phone numbers, pager numbers, fax numbers, e-mail addresses and mailing addresses;
a means for editing said database;
a means for accessing said database;
a means for transmitting a stored message on an outgoing phone line;
a means for selecting a particular time of day for said stored message to be transmitted to said database;
a means for selecting a number of stored message transmission attempts to be made upon receipt of a busy, no answer, or fax signal;
a means for creating a recurring message event;
a means for predetermining the parameters of said message and event; and
a means for entering a text message to be stored and converted to a speech message, said speech message to be transmitted over an outgoing phone line to a database.

2. An automated outbound message delivery system for transmitting outbound messages comprising:
a means for recording a voice message on-line to be stored and transmitted over an outgoing phone line to a database;
a means for playing a stored message, after an outgoing phone call connection has been established, to a database;
a means for playing said stored message upon connection to a voice mail system or answering machine;
a means for prompting the called party, by playing said stored message, after the outgoing connection has been established, to enter one of a plurality of different dial code responses or one of a plurality of voice responses;
a means for recording a touch-tone (digital) or audio response entered by a called party;
a means for compiling and retrieving said response;
a means for delivering said response through facsimile, e-mail, or over the Internet; and
a means for retrieving said responses.

3. The automated outbound message delivery system of claim 1, further comprising a means for downloading a digital audio file to be stored and transmitted over an outgoing phone line to a database.

4. An automated outbound message delivery system of claim 1, further comprising a means for editing said stored message to be transmitted over an outgoing phone line to a database of phone numbers.

5. The system according to claim 2, further comprising a means for requesting and receiving an electronic version of a log indicating the success or failure of call connections in a messaging event.

6. The system according to claim 2, further comprising a means for delivering an electronic version of a log indicating the success or failure of connections in a messaging event.

7. The system according to claim 2, further comprising a means for requesting and receiving a paper copy version of a log indicating the success or failure of connections in a messaging event.

8. The system according to claim 1 wherein said system is internet based and is administered via a graphical user interface.

9. The system according to claim 1 wherein said system comprises a combination of an automated outbound message delivery system with a means for creating a database of phone numbers, pager numbers, fax numbers, e-mail addresses, and mailing addresses, said creating means including a means for having information input into data fields contained within a web page.

10. An automated outbound message delivery system for transmitting outbound messages comprising:
creating a database having information selected from the group consisting of phone numbers, pager numbers, fax numbers, e-mail addresses and mailing addresses;
editing said database;
accessing said database;
transmitting a stored message on an outgoing phone line;
selecting a particular time of day for said stored message to be transmitted to said database;
selecting a number of stored message transmission attempts to be made upon receipt of a busy, no answer, or fax signal;
creating a recurring message event;
predetermining the parameters of said message and event; and
entering a text message to be stored and converted to a speech message, said speech message to be transmitted over an outgoing phone line to a database.

11. An automated outbound message delivery system for transmitting outbound messages comprising:
recording a voice message on-line to be stored and transmitted over an outgoing phone line to a database;
playing a stored message, after an outgoing phone call connection has been established, to a database;
playing said stored message upon connection to a voice mail system or answering machine;
prompting the called party, by playing said stored message, after the outgoing connection has been established, to enter one of a plurality of different dial code responses or one of a plurality of voice responses;
recording a touch-tone (digital) or audio response entered by a called party;
compiling and retrieving said response;
delivering said response through facsimile, e-mail, or over the Internet; and
retrieving said responses.

12. The method according to claim 10, further comprising transmitting a combined broadcast e-mail and voice message.

13. The method according to claim 10, further comprising charging on a per-message or charge per minute pricing basis.

14. The method according to claim 10, further comprising the utilization of an e-commerce engine.

15. The method according to claim 10, further comprising the capability to accept payment by credit card.

16. The method according to claim 10, further comprising an implimenting Internet based marketing and charging a referral fee.

17. The system according to claim 10, wherein the improvement comprising, the use of a web interface to handle fees for sales referrals combined with an outbound message delivery method.

18. The system according to claim 1, further comprising a means for converting an unlimited number of text characters into speech to be stored as a message and transmitted over an outgoing phone line.

19. The system according to claim 1, further comprising buffering the transmission of messages to coincide with non-peak periods of activity for the Inter-Exchange Carrier providing the message delivery function.

20. The method according to claim 10, further comprising using Internet based targeted advertising.

21. The method according to claim 10, further comprising providing a Marketing method for banner advertising and co-branding in which companies and organizations co-brand with CallMachine.com™ so that the web page that a user interacts with appears to be presented by them.

22. The method according to claim 10, further comprising providing a Marketing method for banner advertising and co-branding in which companies and organizations purchase customer specific banner advertising that appears on a web page.
